(19) United States
(12) Patent Application Publication
(10) Pub. No.: US 2025/0342232 A1
(43) Pub. Date: Nov. 6, 2025

(54) PROTECTING TOKENIZED STRUCTURES USING A PROTECTION ARCHITECTURE

(71) Applicant: Wells Fargo Bank, N.A., San Francisco, CA (US)

(72) Inventors: Matthew Mullin Shepherd, Charlotte, NC (US); Nathaniel C. Eutsler, San Francisco, CA (US); Sivakumar Natarajan, San Francisco, CA (US); Piers Varley, San Francisco, CA (US)

(73) Assignee: Wells Fargo Bank, N.A., San Francisco, CA (US)

(21) Appl. No.: 18/652,674

(22) Filed: May 1, 2024

(51) Int. Cl. G06F 21/10; G06Q 20/36

(52) U.S. Cl. CPC G06F 21/1085; G06F 21/1014; G06Q 20/36

(57) ABSTRACT

Systems, methods, and computer-readable storage media to protect tokens using a protection architecture. One method includes identifying asset tokens including links to a plurality of asset metadata objects. Further, the method includes generating a container metadata object including metadata of the asset tokens. Further, the method includes generating a container token including a link with the container metadata object. Further, the method includes encapsulating the container token and the asset tokens within a container including a container control structure restricting outputs of the container metadata object and the plurality of asset metadata objects. Further, the method includes generating an allocation token compatible with a segmented allocation control structure restricting outputs by the container of a first segmented allocation of the asset tokens based on metadata of a subset of the plurality of asset metadata objects. Further, the method includes providing, using the segmented allocation control structure, the allocation token.

### TECHNICAL FIELD

The present implementations relate generally to digital assets, and more particularly to digital asset protection.

### BACKGROUND

The present disclosure relates generally to assets, and more particularly to asset protection. In a computer networked environment such as the internet, users and entities such as people or companies exchange and store tokens. These tokens can represent a variety of asset types, including financial securities, intellectual properties, or other forms of digital assets. As transactions and asset management become increasingly digitized, ensuring the security and integrity of these tokens can be desired. The present disclosure uses blockchain technology to secure and manage asset tokens. Through the use of smart contracts and encryption, the present disclosure provides asset handling implementations that enhance trust and reliability in the exchanging and storing of tokens.

### SUMMARY

Some implementations relate to a system, including a data processing system including memory and one or more processing circuits configured to identify a plurality of asset tokens including links to a plurality of asset metadata objects. The one or more processing circuits are further configured to generate a container metadata object including metadata of the plurality of asset tokens. The one or more processing circuits are further configured to generate a container token including a link with the container metadata object. The one or more processing circuits are further configured to encapsulate the container token and the plurality of asset tokens within a container including a container control structure restricting outputs of the container metadata object and the plurality of asset metadata objects. The one or more processing circuits are further configured to generate an allocation token compatible with a segmented allocation control structure restricting outputs by the container of a first segmented allocation of the plurality of asset tokens based on metadata of a subset of the plurality of asset metadata objects. The one or more processing circuits are further configured to provide, by the segmented allocation control structure to a client system, the allocation token.

In some implementations, the one or more processing circuits are further configured to generate, by the segmented allocation control structure, a plurality of segmented allocations within the container based on an output of the container control structure corresponding to access to the plurality of asset metadata objects.

In some implementations, generating the plurality of segmented allocations includes applying a plurality of parameters to segment the plurality of asset tokens encapsulated within the container, and wherein the token is at least one of a fungible token or a non-fungible token (NFT).

In some implementations, the one or more processing circuits are further configured to request and monitor, by the segmented allocation control structure, the outputs of the container control structure, the outputs including the metadata of the subset of the plurality of asset metadata objects of the first segmented allocation, determine at least one of the plurality of asset tokens of the first segmented allocation conflicts with a first set of the plurality of parameters, generate an updated allocation token compatible with the segmented allocation control structure restricting the output by the container of an updated segmented allocation of the plurality of asset tokens based on metadata of an updated subset of the plurality of asset metadata objects, the updated allocation token satisfying the first set of the plurality of parameters, and provide, by the segmented allocation control structure to the client system, the updated allocation token.

In some implementations, the first segmented allocation includes a first plurality of the plurality of asset tokens satisfying a first set of the plurality of parameters, and a second segmented allocation including a second plurality of the plurality of asset tokens satisfying a second set of the plurality of parameters.

In some implementations, the one or more processing circuits is further configured to request and monitor, by the segmented allocation control structure, the outputs of the container control structure, the outputs including one or more performance metrics of the metadata of the subset of the plurality of asset metadata objects of the first segmented allocation, wherein the metadata of the subset of the plurality of asset metadata objects includes underlying physical asset information and determine an allocation distribution corresponding to the allocation token based on the one or more performance metrics of the first segmented allocation.

In some implementations, the one or more processing circuits is further configured to in response to determining the allocation distribution, either automatically initiate an on-chain exchange of the allocation distribution from an instrument owner's wallet address to a mobile wallet address of the client system, wherein the instrument owner's wallet address corresponds to an instrument owner with a security interest in one or more underlying physical assets of the first segmented allocation of the plurality of asset tokens, or automatically process an off-chain exchange from the instrument owner's wallet address to an account of a user operating the client system.

In some implementations, each of the plurality of asset tokens correspond to a controllable electronic record representing an ownership instrument of at least one security interest in at least one of the plurality of tokens.

In some implementations, providing, by the segmented allocation control structure to the client system, the allocation token is responsive to (1) receiving a first allocation request including a first amount in exchange for a portion of an allocation distribution of the first segmented allocation or (2) a re-allocation, after a threshold time period, of the first segmented allocation and receiving a second allocation exchange request including a second exchange amount for a re-allocated portion of a re-allocated allocation distribution of the re-allocated first segmented allocation.

Some implementations relate to a method, including identifying, by one or more processing circuits, a plurality of asset tokens including links to a plurality of asset metadata objects. The method further includes generating, by the one or more processing circuits, a container metadata object including metadata of the plurality of asset tokens. The method further includes generating, by the one or more processing circuits, a container token including a link with the container metadata object. The method further includes encapsulating, by the one or more processing circuits, the container token and the plurality of asset tokens within a container including a container control structure restricting outputs of the container metadata object and the plurality of asset metadata objects. The method further includes generating, by the one or more processing circuits, an allocation token compatible with a segmented allocation control structure restricting outputs by the container of a first segmented allocation of the plurality of asset tokens based on metadata of a subset of the plurality of asset metadata objects. The method further includes providing, by the one or more processing circuits using the segmented allocation control structure to a client system, the allocation token.

In some implementations, the method further including generating, by the one or more processing circuits using the segmented allocation control structure, a plurality of segmented allocations within the container based on an output of the container control structure corresponding to access to the plurality of asset metadata objects.

In some implementations, generating the plurality of segmented allocations includes applying a plurality of parameters to segment the plurality of asset tokens encapsulated within the container, and wherein the token is at least one of a fungible token or a non-fungible token (NFT).

In some implementations, the method further including requesting and monitoring, by the one or more processing circuits using the segmented allocation control structure, the outputs of the container control structure, the outputs including the metadata of the subset of the plurality of asset metadata objects of the first segmented allocation, determining, by the one or more processing circuits, at least one of the plurality of asset tokens of the first segmented allocation conflicts with a first set of the plurality of parameters, generating, by the one or more processing circuits, an updated allocation token compatible with the segmented allocation control structure restricting the output by the container of an updated segmented allocation of the plurality of asset tokens based on metadata of an updated subset of the plurality of asset metadata objects, the updated allocation token satisfying the first set of the plurality of parameters, and providing, by the one or more processing circuits using the segmented allocation control structure to the client system, the updated allocation token.

In some implementations, the first segmented allocation includes a first plurality of the plurality of asset tokens satisfying a first set of the plurality of parameters, and a second segmented allocation including a second plurality of the plurality of asset tokens satisfying a second set of the plurality of parameters.

In some implementations, the method further including requesting and monitoring, by the one or more processing circuits by the segmented allocation control structure, the outputs of the container control structure, the outputs including one or more performance metrics of the metadata of the subset of the plurality of asset metadata objects of the first segmented allocation, wherein the metadata of the subset of the plurality of asset metadata objects includes underlying physical asset information and determining, by the one or more processing circuits, an allocation distribution corresponding to the allocation token based on the one or more performance metrics of the first segmented allocation.

In some implementations, the method further including in response to determining the allocation distribution, either automatically initiating, by the one or more processing circuits, an on-chain exchange of the allocation distribution from an instrument owner's wallet address to a mobile wallet address of the client system, wherein the instrument owner's wallet address corresponds to an instrument owner with a security interest in one or more underlying physical assets of the first segmented allocation of the plurality of asset tokens or automatically processing, by the one or more processing circuits, an off-chain exchange from the instrument owner's wallet address to an account of a user operating the client system.

In some implementations, each of the plurality of asset tokens correspond to a controllable electronic record representing an ownership instrument of at least one security interest in at least one of the plurality of tokens.

In some implementations, providing, by the segmented allocation control structure to the client system, the allocation token is responsive to (1) receiving a first allocation request including a first amount in exchange for a portion of an allocation distribution of the first segmented allocation or (2) a re-allocation, after a threshold time period, of the first segmented allocation and receiving a second allocation exchange request including a second exchange amount for a re-allocated portion of a re-allocated allocation distribution of the re-allocated first segmented allocation.

Some implementations relate to a non-transitory computer readable medium (CRM) including one or more instructions stored thereon and executable by one or more processing circuits to identify a plurality of asset tokens including links to a plurality of asset metadata objects, generate a container metadata object including metadata of the plurality of asset tokens, generate a container token including a link with the container metadata object, encapsulate the container token and the plurality of asset tokens within a container including a container control structure restricting outputs of the container metadata object and the plurality of asset metadata objects, generate an allocation token compatible with a segmented allocation control structure restricting outputs by the container of a first segmented allocation of the plurality of asset tokens based on metadata of a subset of the plurality of asset metadata objects, and provide, by the segmented allocation control structure to a client system, the allocation token.

In some implementations, the one or more instructions stored thereon and executable by the one or more processing circuits further to generate, by the segmented allocation control structure, a plurality of segmented allocations within the container based on an output of the container control structure corresponding to access to the plurality of asset metadata objects.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 depicts an example system, according to some implementations.

FIG. 2 depicts a block diagram illustrating an example computing system for use in the various implementations described herein.

FIG. 3 depicts an example protection architecture, according to some implementations.

FIG. 4 depicts another example protection architecture, according to some implementations.

FIG. 5 depicts a method to protect tokens using a protection architecture, according to some implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

The technical solution described herein can including smart contract control structures and a secure container that encapsulates one or more tokens. The smart contract control structures can allow output of various metadata linked to the tokens upon detection of NFTs, semi-fungible tokens, or fungible tokens compatible with the smart contract control structures or particular requests (e.g., distribution, exchange, withdrawal, deposit, exchange instrument, on-us exchange). For example, the smart contract control structures can be restricted to execution at a particular computing environment by a container token restricted to within the particular computing environment. The smart contract control structures, and the tokens within the smart contract control structures, can be rendered unusable outside the particular computing environment. This technical solution can include multiple layers of secure access control to tokens, including authorization control at a smart contract layer by one or more tokens, and authorization control at a container layer by a private key. The private key can be based on one or more tokens, and can be fully contained within a single tokens or partially contained within multiple tokens. This technical solution can include generation of smart contract control structures and modification of blockchain architecture to restrict particular tokens. A smart contract control structure can, for example, generate or modify a smart contract to contain one or more particular tokens. The smart contract control structures can search a blockchain to identify tokens satisfying particular attributes, parameters, or metrics. The parameters can be transmitted to the generated smart contract by a token. The generated smart contract control structures can generate a token that can include an NFT, a semi-fungible toke, or a fungible token, and can distribute that token while retaining locally the smart contract and its restricted tokens.

Accordingly, the systems, computer-readable media, and methods described herein provide improvements over typical asset exchange systems and data storage/access system. That is, the technical problem that arises from typical exchange systems and data systems occurs when assets and data of the assets are stored and transferred (e.g., physical or digitally) with minimal security or authorization checks. For example, when a digital asset is stored or exchanged by a user device, the digital asset itself and data stored in or on the digital asset may have been modified or changed (e.g., compromised) without knowledge of the asset exchange system or data storage/access system. For example, digital assets may be vulnerable to compromise (e.g., stealing, spoofing, hacking, etc.) by hackers. Thus, to improve asset protection and data security, the technical solution is accomplished by obfuscating and protecting the assets (e.g., digital, physical) utilizing a token (e.g., fungible tokens, non-fungible tokens, and/or partially-fungible tokens-collectively referred to as a “digital asset token”) that is restricted utilizing one or more particular control structures and protected utilizing blockchain ledgers and structures described herein. This not only protects assets from hackers (or third-parties) by reducing or eliminating the exposure or potential for manipulation of protected or private information of assets at client systems (e.g., provider, user, goods or service provider), but also protects entities and users from exposing their protected or private information (e.g., banking, sensitive, financial), which is a significant improvement to the security and integrity of assets and data that are exchanged and stored.

Moreover, aspects of the present disclosure address problems in the speed and resource requirement/allocation associated with verifying and processing token exchanges, allocation segmentations, and distributions. Additionally, aspects of the present disclosure address problems in the issuance of dynamic exchange and distribution instruments that includes internal states that dynamically change in real-time or near real-time. In some implementations, the systems and methods described herein can issue and dynamically update segmented allocations and tokens. That is, since an asset's value or other financial parameters (represented and/or linked to a token in metadata) or use can fluctuate often, the systems and methods described herein provide improvements over current token exchange and distribution instruments by providing a physical and digital distribution and exchange instrument that can monitor and provide (e.g., present on the physical or digital exchange instrument) real-time information about the internal states of the tokens and segmented allocations can be update in real-time or near real-time to protect the issuer of the token. Thus, aspects of the present disclosure improve the issuance and monitoring of dynamic exchange and distribution instruments linked to tokens by offering real-time information to the holder (or someone having rights to the underlying asset) and updating segmented allocations and internal states of the token in real-time or near real-time based on continuously monitoring the asset represented by the token.

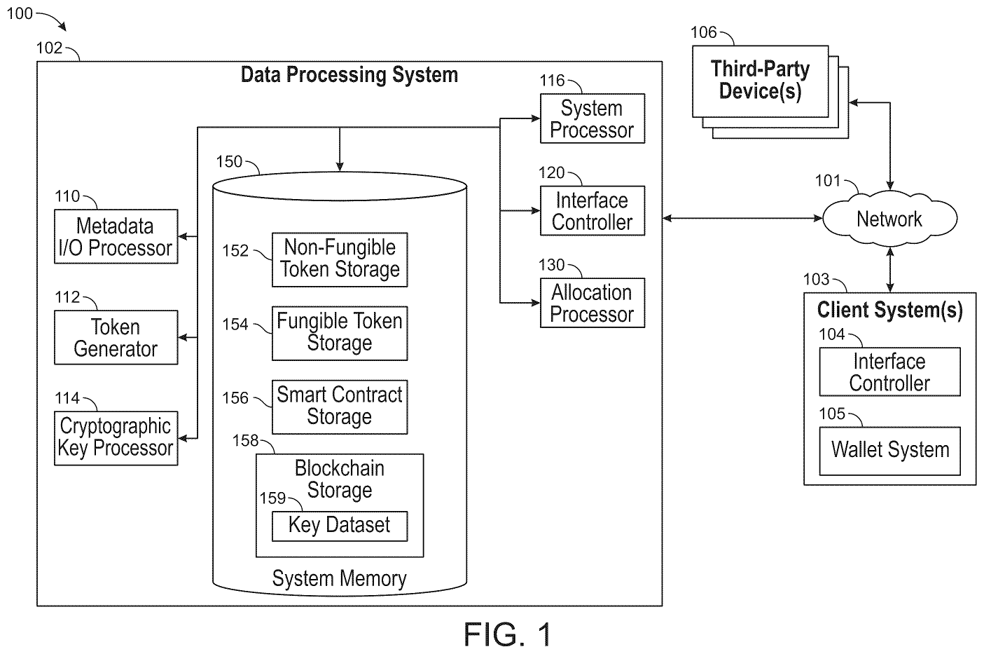

FIG. 1 depicts an example system, in accordance with present implementations. As illustrated by way of example in FIG. 1, an example system 100 can include at least a network 101, a data processing system 102, a client system 103, and a third-party device 106. The network 101 can include any type or form of network. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks 101. The network 101 can include any such network topology as known to those ordinarily skilled in the art capable of supporting the operations described herein. The network 101 can utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite can include application layer, transport layer, internet layer (including, e.g., IPv6), or the link layer. The network 101 can include a type of a broadcast network, a telecommunications network, a data communication network, or a computer network.

The data processing system 102 can include at least one physical computer system operatively coupled or that can be coupled with one or more components of the system 100, either directly or directly through an intermediate computing device or system. The data processing system 102 can include at least one virtual computing system, at least one operating system, and at least one communication bus to effect communication and processing. The data processing system 102 can include a metadata I/O processor 110, token generator 112, system processor 116, interface controller 120, allocation processor 130, and a system memory 150. It should be understood that the data processing system 102 can be a provider computing system associated with a provider. The provider can be a financial institution, an investment firm, a credit union, a brokerage, or a bank. That is, the data processing system 102 can be managed by, owned by, or otherwise associated with a provider entity or institution.

Generally, the data processing system 102 can implementing the automatic creation of tranches via detection of certain conditions using fungible tokens. For example, the assets may be asset-backed securities, mortgage-backed securities, or another pooled set of securities. In typical operation, assets can be provided, which may be bonds or another type of asset and a servicer can paid to collect cash flows based on the assets. In these operations, a trustee can track who owns what and whether the asset (e.g., bond) is meeting certain conditions. When conditions are met, they pull the asset out. For example, a mortgage may be 90-day delinquent, and the trustee/system removes that mortgage when it hits that mark. Instead, the data processing system 102 can pool assets and individual assets can be minted into a NFT (or another token) for the pool and individual NFTs (or other tokens) representing the individual assets. This can create an immutable data trail. In some implementations, the data processing system 102 can actively monitor the pooled asset NFT and the individual asset NFTs. For example, there may be a plurality of pooled asset NFTs that each have individual asset NFTs. In some implementations, the data processing system 102 may receive various predefined tranche characteristics, such as a loan type, a maturity date, an interest rate, a remaining principal, and so on. For example, regarding mortgage-backed securities, one trigger condition may be whether the customer is paying the mortgage. If yes, the data processing system 102 can classify it into one tranche; and if not, the data processing system 102 classify it into another tranche. Furthermore, tranching may broke down into more granularity as well, such as if the consumer is paying more than the required minimum or less than the required minimum may lead to different tranche classifications. For example, as the individual assets are monitored, conditions of the individual assets may be identified (e.g., the dynamic remaining principal amount, changing interest rates, etc.). In some implementations, based on the characteristics of the individual assets, the data processing system 102 may tranche the individual assets. For example, the tranche creation may be specific to the already-pooled asset. In another example, the tranche creation may be done via individual assets across a plurality of pooled assets. In some implementations, the tranche creation may be dynamic in nature to reflect the changing characteristics of the individual assets. Furthermore, the NFT characteristic of the individual assets provides immutable tracking of the assets. In some implementations, the generated tranches may be provided for sale. If not sold, the generated tranches may be re-evaluated the data processing system 102 repeated until the securitization of the tranche is enabled. This has the advantage of continuously working in order to promote a sale.

The metadata input/output (I/O) processor 110 is at least one processor structured or configured to identify metadata (sometimes referred to as “attributes” or “rules” or “characteristics”) of one or more tokens. For example, the metadata I/O processor 110 can identify one or more characteristics of an individual token or a plurality of tokens satisfying one or more criteria. The metadata I/O processor 110 can generate a particular feature corresponding to one or more characteristics of a token, a segmented allocation including a token, or a metadata linked with the token. For example, a feature can include a scalar or vector quantity corresponding to one or more distributions of an aspect of a token. For example, a feature can include a list of coordinates corresponding to a line identified in an image linked with a token. For example, a feature can include a numeric value corresponding to an identifier of token. For example, criteria by which token can be identified can include aspects of the token, fields or components of the token, transform processes used to generate or modify the token, aspects of a metadata object linked with the token, or any combination thereof. For example, aspects of the token can include a hash of the token, or a value of an individual field of the token. For example, aspects of a metadata object linked with the token can include a bitmap of an image linked with the token, or a hash of a media metadata linked with the token. Media metadata can include images, audio, three-dimensional (3D) models, or any combination thereof.

The metadata I/O processor 110 is also structured or configured to generate and modify one or more metrics based on one or more tokens. For example, the metadata I/O processor 110 can generate a metric based one or more features obtained from the token storages 152 and 154. For example, the metadata I/O processor 110 can generate a performance metric to indicate a particular distribution amount or type of a particular token. The metadata I/O processor 110 can generate metrics compatible with particular thresholds. Additionally, the metadata I/O processor 110 can obtain one or more metadata objects. The metadata I/O processor 110 can communicate with one or more external systems via the network 101, and can obtain one or more metadata objects via the network 101. The metadata I/O processor 110 can generate metadata objects that can be transmitted to a computing device, including, for example, the client system 103. The metadata I/O processor 110 can identify one or more characteristics of a metadata object. For example, the metadata I/O processor 110 can obtain and identify metadata objects of a segmented allocation including video, audio, text, any media, executable programs, or any combination thereof. The metadata I/O processor 110 can transmit one or more of metadata objects or references or links with one or more metadata objects to the token generator 112.

The token generator 112 it at least one processor structured or configured to generate and modify one or more smart contracts. The token generator 112 can execute instructions to generate or modify a cryptographic container, to add or remove objects from a cryptographic container, and to execute various processors linked with or embedded with a smart contract. For example, the token generator 112 can execute various processors of a smart contract in response to an indication from the metadata I/O processor 110 that a performance metric satisfies a particular threshold for distribution. For example, the token generator 112 can execute various processors implementing smart contracts in response to detecting input including or corresponding to a particular token at the smart contract. For example, the token generator 112 can include processors to read, write, generate, or modify one or more objects contained within a container of the smart contract, one or more tokens input to the smart contract, or one or more processors.

Additionally, the token generator 112 is structured or configured to validate one or more tokens against one or more smart contracts. The token generator 112 can obtain one or more tokens, and can compare one or more token to one or more tokens requested by a particular smart contract. The token generator 112 can detect whether a particular token is compatible with a particular smart contract by detecting whether a particular token matches a particular token characteristic associated with a particular smart contract. For example, the token generator 112 can detect that a token is compatible with a smart contract based on comparing a hash of the token with a hash included in the smart contract. The token generator 112 can generate an authorization indication based on one or more determinations, and can transmit the authorization indication to the system processor 116. The token generator 112 can, for example, provide a control structure or one or more metadata objects to the system processor 116, in response to the authorization indication, by decrypting an encapsulation layer of the control structure. The token generator 112 can, for example, execute the smart contract with the compatible tokens to retrieve a particular control structure for the smart contract, or a reference to the particular control structure, from the smart contract storage 156.

The system processor 116 is at least one processor structured or configured to execute one or more instructions associated with the system 100. The system processor 116 can include an electronic processor, an integrated circuit, or the like including one or more of digital logic, analog logic, digital sensors, analog sensors, communication buses, volatile memory, nonvolatile memory, and the like. The system processor 116 can include, but is not limited to, at least one microcontroller unit (MCU), microprocessor unit (MPU), central processing unit (CPU), graphics processing unit (GPU), physics processing unit (PPU), embedded controller (EC), or the like. The system processor 116 can include a memory operable to store or storing one or more instructions for operating components of the system processor 116 and operating components operably coupled to the system processor 116. The one or more instructions can include at least one of firmware, software, hardware, operating systems, embedded operating systems, and the like. The system processor 116 or the system 100 generally can include at least one communication bus controller to effect communication between the system processor 116 and the other elements of the system 100.

The interface controller 120 can communicate with one or more external systems compatible with transferring a token (e.g., container token, asset token, allocation token). The interface controller 120 can be implemented using processing circuits that can include processors and memory. Examples of such processing circuits could include microprocessors for executing software instructions, digital signal processors for managing data transmissions, and volatile or non-volatile memory units for storing operational data and token information. For example, the interface controller 120 can include an application programming interface (API) compatible with the third-party device 106 and the client system 103. For example, the interface controller 120 can be configured to receive characteristics associated with particular tokens, types of tokens, particular segmented allocations of tokens, or metadata objects linked with particular tokens. For example, the interface controller 120 can be configured to receive particular quantitative values corresponding to particular distributions of a segmented allocation of asset tokens within a particular container token. The interface controller 120 can provide the technical improvement of providing a communication interface compatible with particular token transfer and distribution operations.

The allocation processor 130 is at least one processor in the data processing system 102 that is structured or configured to execute operations related to the generation and management of segmented allocation smart contract control structures. In some implementations, the allocation processor 130 can process tasks and actions such as classifying asset tokens within container tokens based on parameters set in the smart contracts. The allocation processor 130 can interact with blockchain 158 to deploy the contracts, dynamically adjust asset segmentation in response to changes in metadata, and manage the issuance and authentication of allocation tokens. Additionally, the allocation processor 130 can interface with the blockchain 158 to record and maintain logs of all distributions and modifications in token allocations, aligned with the predefined rules and conditions of the smart contracts.

The allocation processor 130 in the data processing system 102 can be also configured to manage the computational tasks for determining and updating the segmentation of asset tokens within container tokens based on defined parameters. These parameters may include financial metrics such as loan type, maturity date, interest rate, credit risk, payment history, and principal amount remaining. The allocation processor 130 can generate and use the parameters to classify and reclassify asset tokens into appropriate segmented allocations, such as tranches or risk pools, in accordance with the smart contract specifications. Additionally, the allocation processor 130 can initiate distributions based on performance metrics. The allocation processor 130 can be programmed to automatically calculate and trigger financial distributions or other outputs once the underlying asset tokens meet specific performance thresholds, which can be detailed in the smart contracts (e.g., in smart contract storage 156). This can include evaluating compliance with payment schedules and adjusting distributions as asset conditions change, providing that token holders (e.g., client systems 103 and third-party devices 106) receive returns that reflect the current performance of their investment holdings. The allocation processor 130 can interact with blockchain 158 to execute these functions.

The system memory 150 is at least one memory device or repository configured or structured to store data associated with the system 100. The system memory 150 can include one or more hardware memory devices to store binary data, digital data, or the like. The system memory 150 can include one or more electrical components, electronic components, programmable electronic components, reprogrammable electronic components, integrated circuits, semiconductor devices, flip flops, arithmetic units, or the like. The system memory 150 can include at least one of a non-volatile memory device, a solid-state memory device, a flash memory device, and a NAND memory device. The system memory 150 can include one or more addressable memory regions disposed on one or more physical memory arrays. A physical memory array can include a NAND gate array disposed on, for example, at least one of a particular semiconductor device, integrated circuit device, and printed circuit board device. The system memory 150 can include an NFT storage area/repository 152, a fungible token storage area/repository 154, a smart contract storage area/repository 156, and a blockchain storage area/repository 158 including a key dataset 159. These areas/repositories may be separate memory devices and/or electronically isolated modules/memory portions within the system memory 150.

The NFT storage 152 can store one or more NFTs and corresponding addresses for particular NFTs that indicate links with the corresponding NFT. The NFT storage 152 can include NFTs associated with the data processing system 102 or any component thereof, the client system 103 or any component thereof, any metadata object, or any combination thereof. The key dataset 159 can store cryptographic keys associated with the data processing system 102 or any component thereof, the client system 103 or any component thereof, any metadata object, or any combination thereof. For example, the key dataset 159 can include public-private key pairs or private keys corresponding to particular accounts, NFTs, smart contracts, devices, users, systems, or any combination thereof.

The fungible token storage 154 can store one or more fungible tokens and semi-fungible tokens. The fungible token storage 154 can store corresponding addresses for particular fungible tokens that indicate links with the corresponding fungible tokens, and can store corresponding addresses for particular semi-fungible tokens that indicate links with the corresponding semi-fungible tokens. The non-fungible token storage 152 can include fungible tokens and semi-fungible tokens associated with the data processing system 102 or any component thereof, the client system 103 or any component thereof, any content object, or any combination thereof. The key dataset 159 can store cryptographic keys associated with the data processing system 102 or any component thereof, the client system 103 or any component thereof, any metadata object, or any combination thereof. For example, the key dataset 159 can include public-private key pairs or private keys corresponding to particular accounts, fungible tokens, smart contracts, devices, users, systems, or any combination thereof.

The smart contract storage 156 can store one or more smart contracts and corresponding addresses for particular smart contracts that indicate links with the corresponding smart contracts. The smart contract storage 156 can also store one or more control structures and their contained metadata objects and corresponding addresses for particular control structures that indicate links with the corresponding control structures. The blockchain storage 158 can store one or more blockchains linked to one or more smart contracts, tokens, control structures, or metadata objects, by corresponding addresses for particular smart contracts, tokens, control structures, or metadata objects that indicate links with a particular blockchain.

The client system 103 can include a computing system located remotely from the data processing system 102. The client system 103 can include a wallet system 105. The wallet system 105 can include an interface to execute instructions corresponding to a particular wallet account, and to modify the structure or contents of a particular smart contract corresponding to a wallet account. For example, the mobile wallet system 105 can include a user interface to receive allocation tokens and input that indicates selections of various tokens, transactions, accounts, devices, users, or systems. For example, the user interface can include a graphical user interface (GUI) that can be presented at a display device. The display device can display at least one or more user interface presentations, and can include an electronic display. An electronic display can include, for example, a liquid crystal display (LCD), a light-emitting diode (LED) display, an organic light-emitting diode (OLED) display, or the like. The display device can receive, for example, capacitive or resistive touch input. The mobile wallet system 105 can transmit one or more instructions, tokens, keys, or any combination thereof to, from, or with the data processing system 102.

The client system 103 may be used by a third party with a relationship to the third-party device 106 or data processing system 102 (e.g., vendor, customer, entity, supplier, and so on) to perform various actions and/or access various types of data, some of which may be provided over network 101. The term “client” as used herein may refer to an individual (or multiple individuals) operating one or more client systems 103 and interacting with resources or data via the client system 103. The client system 103 may be used to electronically transmit data (e.g., exchange requests, parameters, tokens, receive allocation tokens or distributions, etc.) to the data processing system 102, to access websites (e.g., using a browser), the internet (e.g., using a mobile application, such as a decentralized application (dApp)), supply services, supply products, and to receive and/or transmit any other types of data (e.g., geographic location data of digital or physical assets, environment data of digital or physical assets).

The client system 103 (sometimes referred to herein as a “computing system”) may be a mobile computing device, desktop computer, smartphone, tablet, smart watch, smart sensor, or any other device configured to facilitate receiving, displaying, and interacting with content (e.g., web pages, mobile applications, such as decentralized application (dApp), etc.). Client system 103 may also include an interface controller 104 for communicating data over network 101 to data processing system 102 and third-party devices 106. In some implementations, each client system 103 can have a digital wallet address or exchanging (e.g., receiving or sending) fungible or non-fungible values (e.g., cryptocurrency, digital currency, stocks, bonds, loan, deed, etc.).

The interface controller 104 can link the client system 103 with one or more of the network 101 and the data processing system 102 by one or more communication interfaces. A communication interface can include, for example, an application programming interface (“API”) compatible with a particular component of the data processing system 102 or the data processing system 102. The communication interface can provide a particular communication protocol compatible with a particular component of the data processing system 102 and a particular component of the client system 103. The interface controller 104 can be compatible with particular metadata objects, and can be compatible with particular token delivery systems corresponding to segmented allocations of tokens encapsulated within control structures. For example, the interface controller 104 can be compatible with transmission of video content, audio content, or any combination thereof. For example, the interface controller 104 can be compatible with payment processing transmissions by a protocol compatible with payment processing latency and encryption structures. The communication interface of the client system 103 can be compatible with the communication interface of the data processing system 102 to perform unidirectional or bidirectional communication between the interface controllers 104 and 120.

The third-party device 106 can transfer a token or provide token distributions based on one or more smart contracts, blockchains, systems, or any combination thereof, or the like. The third-party device 106 can include an exchange or distribution network to identify particular token and transfer particular tokens or distribution particular funds from a token between particular wallet accounts or systems, for example. The third-party device 106 can receive an instruction to provide a distribution for a particular segment allocation of asset tokens from a first account to a second account, and can be linked with a quantitative value indicating a value of the distribution. For example, the quantitative value can correspond to a value of fiat currency, math-based currency (MBC), or any combination thereof. For example, MBC can include cryptocurrency or the like. The third-party device 106 can detect characteristics associated with particular tokens, types of tokens, or metadata objects linked with particular tokens, and can detect particular quantitative values corresponding to particular transfer or distributions of tokens.

Still referring to FIG. 1, in some implementations, upon receiving or generating a token the cryptographic key processor 114 can identify public key(s) and/or private key(s) associated with the token. For example, the cryptographic key processor 114 upon identifying private keys of the token, can verify the token using one or more identified private keys. In the following example, the token may have been previously stored on data processing system 102 and the public-private key pairs may be stored throughout the data processing system 102 (e.g., in blockchain storage 158). In some implementations, the received token may be an external token stored on storage medium or cache remote from the data processing system 102 (e.g., digital wallet, crypto-wallet, any other storage medium or cache), such as on client system 103 or third-party device 106. In particular, an external token received by the data processing system 102 can initiate a key generation process by the cryptographic key processor.

In some implementations, the cryptographic key processor 120 can sign the NFT using a private key and verify the NFT using a public key. Thus, in some implementations, verifying can include decrypting the NFT using the public key to verify the digital signature came from the particular private key (e.g., particular digital wallet of a user), and signing can include encrypting the NFT using the private key to create a digital signature. In various implementations, cryptographic key processor 120 can sign the NFT using a public key and verify the NFT using a private key. Thus, in various implementations, verifying can include decrypting the NFT using the private key to verify the digital signature came from the particular public key or public address (e.g., particular digital wallet of a user), and signing can include encrypting the NFT using the public key to create a digital signature. It should be understood that a public key and public address are used herein interchangeably, but in some implementations, the public address may be a hashed version of the public key based on a hash function. In some implementations, the keys may be symmetric (e.g., use the same key to sign/verify) or asymmetric (e.g., use different keys to sign/verify). For example, each key of the public-private key pair may identical. In another example, an algorithm (e.g., such as a hash algorithm) can be applied to a private key to generate a public key. Accordingly, public keys can be a cryptographic code that allows users and system described herein to receive digital assets and verify them prior to amending and/or updating a ledger (e.g., 168, 182).

Still referring to FIG. 1, in some implementations, the interface controller 120 can establish a data channel between a source address and a destination address, such that receivals or transmissions of a token or token distributions occurs between the addresses on a ledger (e.g., blockchain storage 158) and/or a digital wallet (e.g., wallet system 105). An address can be generated based on executing, by the cryptographic key processor 114, a math-based function (e.g., hash, symmetric encryption, asymmetric encryption) on a public key of a public and private key pair (or a verification key of a verification and signing key pair). For example, if an interface controller 120 receives a token from any system or device described herein, the token or other data received may include metadata associated with a source address, and the interface controller 120 may determine a destination address (e.g., may be provided to the system sending the NFT in advance) to store the token or provide a distribution in the blockchain storage 158. In various implementations, the addresses may be a unique sequence of randomized (or pseudo-randomized) numerical digits, characters, punctuation, whitespace, code (e.g., QR), or symbols.

In some implementations, the cryptographic key processor 114 can also be configured to generate public and private key pairs and the interface controller 120 can be configured to provide public keys (e.g., or public and private key pairs, or private keys) to one or more computing devices (e.g., client system 103, third-party device 106) for use in a token exchange or token distribution. That is, the interface controller 120 can interface (e.g., using an API) with one or more other ledger systems (other blockchain ledgers) and wallets (e.g., digital, crypto, and so on). In various implementations, the public and private key pair can be generated based on a cryptographic function (e.g., symmetric-key algorithms (such as DES, AES), asymmetric-key algorithms (Ed25519 signing, ECC), public-key algorithms (such as RSA), and so on) and be stored in the data processing system 102. In various implementations, the public-private key pairs may be stored in key dataset 159. In some implementations, the data processing system 102 can maintain (e.g., store and access keys) the key dataset 159 such that each token may be locked-unlocked and associated with a public key or public-private key pair stored on the key dataset 159. In various implementations, public-private key pairs can be shared amongst a plurality of tokens or can be unique to each token on the blockchain storage 158.

In various implementations, any data shared over network 101 or within data processing system 102 can be encrypted and/or secured (e.g., hashed, password protected) to prevent unauthorized parties from performing unauthorized actions on the intermittent secure connection. For example, a masking algorithm may be executed performing bitwise operations (e.g., NOT, AND, NAND, OR, XOR, Complement, left-shift (logical or arithmetic), right-shift (logical or arithmetic), rotate right, rotate left, and so on) on any data transferred over the intermittent secure connection. Additionally, all communications over the intermittent secure connection can be encrypted with one or more secure network protocols (e.g., Secure Shell (SSL), Kerberos, IPSec, Secure Sockets Layer (SSL), Hypertext Transfer Protocol Secure (HTTPS), and so on) implemented utilizing a cryptographic function (e.g., symmetric encryption, asymmetric encryption, hashing, and so on). For example, the cryptographic function could be a homomorphic encryption function. In other examples, the cryptographic function could be any symmetric encryption function (e.g., Triple Data Encryption Standard (TDES), RC5, Advanced Encryption Standard (AES), Blowfish, CAST, and so on), and/or asymmetric encryption function (e.g., Rivest-Shamir-Adleman (RSA), Efficient and Compact Subgroup Trace Representation (ECSTR or XTR), Digital Secure, Escrowed Encryption Standard (EES), and so on).

Still referring to FIG. 1, in some implementations, the data processing system 102 may receive a deposit of tokens from the client system 103, and the client system 103 may have an account with the data processing system 102. In the following example, the data processing system 102 may encapsulate and deposit the token (e.g., after verifying the digital signature) on the data processing system 102. Additionally in some implementations, a deposit can include extrapolating (by the interface controller 120) various information from the token and storing the information in various storages (e.g., blockchain storage 158). In one example, a deposit of a token can include updating a token account of a plurality of token accounts in the system memory 150 by recording ownership of the token with the token account. In the following example, a deposit can further include generating and storing a private key (e.g., by cryptographic key processor 114) of the token and at least a first portion of metadata of the metadata object of the token. In the following example, a deposit can further include broadcasting the token to the blockchain storage 158 at the internal address (e.g., hash of an internal public key).

As used herein, “wallet keys” (including wallet public-private key pairs, wallet public key, and wallet private key) can be cryptographic keys of a token (e.g., NFT or fungible token) used by the client system 103 to sign the token (e.g., allocation token), verify the token, and protect the token. As used herein, “internal keys” (including internal public-private key pairs, internal public key, and internal private key) can be cryptographic keys of a token (e.g., NFT) used by the data processing system 102 to sign the token (e.g., container token, asset token, or allocation token), verify the token, and protect the token.

In some implementations, verifying and/or authenticating a token (e.g., container token, asset token, or allocation token) can include communicating (e.g., by the interface controller 120) with other systems (e.g., ledgers or digital wallets) to notify the other systems that the token was verified and/or authenticated (e.g., transferred and stored on data processing system 102). For example, the client system 103 or third-party device 106 may provide a signed asset token to the data processing system 102 (e.g., deposit). In the following example, data processing system 102 can receive the asset token and perform verification and/or authentication. Upon verifying and/or authenticating, data processing system 102 may notify (e.g., send a message) the client system 103 or third-party device 106 (e.g., whoever transmitted the token) that a token (or a plurality of NFTs) were verified and/or authenticated. Further in this example, the client system 103 or third-party device 106 may in turn destroy or update the digital wallet (or ledger) based on the successful verification. In some implementations, when the token (or tokens) are transferred between computing systems or device, the sender's ledger or wallet (e.g., in wallet system 105) may be voided since the public-private key pair would be invalid (e.g., cannot be used to sign or verify an exchange). That is, while the ledger or wallet may not destroy or update the token when they are transferred to the data processing system 102, the token on the sender's ledger or wallet would be unusable or unvalued.

In some implementations, the interface controller 112 may receive a withdrawal or exchange request of one or more tokens stored on the data processing system 102, where a user (e.g., operating the client system 103) may have an account with the data processing system 102. Further in this example, the data processing system 102 may in turn destroy the token and/or update the storages (e.g., 152, 154, 156, 158) based on the successful withdrawal or exchange. In some implementations, when an token is exchanged between data processing system 102 and another ledger or wallet (e.g., wallet system 105 of client system 103 or third-party device 106), the token may be voided or burned since the public-private key pair would be invalid (e.g., cannot be used to sign or verify an exchange). Voiding or burning can include transmitting the token to an un-spendable address (e.g., where no one knows the private key). That is, while the blockchain storage 158 may not destroy or update the token when they are exchanged to a different ledger or off-chain, the token on the sender's ledger would be unusable or unvalued.

Referring to the blockchain storage 158 (sometimes referred to herein as a “blockchain ledger 158”) described herein generally. The blockchain storage 158 (or ledger) can include a key dataset 159 and a blockchain. The blockchain storage 158 can be configured to store and/or maintain any of the information described herein (e.g., tokens or portions of tokens, smart contracts, public and private key pairs, etc.). In some implementations, the described ledger systems and methods involve utilizing one or more processing circuits. The one or more processing circuits allow receiving, collecting, and sending of metadata, allocations, exchange requests (e.g., withdrawal, deposit), public and private key pairs, attributes, smart contracts, and so on. The one or more processing circuits can then communicate with one or more nodes of the blockchain storage 158 and execute one or more smart contracts stored on the nodes to perform various checks (e.g., signing, verifying, distributing, exchanging).

Still referring to FIG. 1, in various implementations, the key dataset 159 can include a plurality of public and private key pairs (referred to hereafter as “key pairs”). In some implementations, the key dataset 159 may include a public key and a pointer (e.g., cold storage public key, hash address, or cold storage address) to a cold storage object stored in cold storage ledger. In some implementations, the key dataset 159 can include a hardware security module (HSM) that can manages cryptographic keys. Each key pair can be stored in the key dataset utilizing a cryptographic function. For example, the cryptographic function could be a homomorphic encryption function. In another example, the cryptographic function could be any symmetric encryption function (e.g., Triple Data Encryption Standard (TDES), RC5, Advanced Encryption Standard (AES), Blowfish, CAST, and so on), and/or asymmetric encryption function (e.g., Rivest-Shamir-Adleman (RSA), Efficient and Compact Subgroup Trace Representation (ECSTR or XTR), Digital Secure, Escrowed Encryption Standard (EES), and so on). In some implementations, the private key can be used to encrypt tokens (e.g., using a cryptographic function to sign) at the source system when an exchange occurs (e.g., send tokens from a source address to a destination address). In various implementations, the public key can be used by the destination system to decrypt (e.g., verify) the encrypted token. For example, the sender (source) of a token stored in a digital wallet can sign (e.g., “lock”) the token or data package including the token to be exchanged with a private key stored in a digital wallet or on the user device (e.g., client system 103 or third-party device 106) of the user and in turn, transmit the token and share the public key for verifying (e.g., “un-locking”) by the receiver, such as the data processing system 102. Additionally in some implementations, the public key can be used to encrypt tokens and the private key can be used to decrypt the encrypted token. For example, the sender (source) of a token stored in a digital wallet can sign the exchange with a public key of and shared by the receiver (destination), and the receiver can in turn, verify the received token and/or data package including the token using the private key of the receiver.

In some implementations, the blockchain storage 158 can include a plurality of nodes configured to store a copy of a plurality of tokens. In various implementations, each node may contain a copy of an individual token associated with a token account of the data processing system 102. In various implementations, the plurality of nodes on the blockchain storage 158 can be interconnected via a central node (e.g., centralized or generalized). Indeed, each node can perform various operations (e.g., execute smart contracts, update tokens) on-chain (e.g., on blockchain storage 158) or off-chain. Thus, the central node can operate as an intermediary between any system or device with data not stored on the blockchain storage 158 such that, any communications (e.g., segmented allocation requests, exchange, withdrawals or deposits, updates, public and private key access) first is received by the central node. As such, the central node may be configured to route communications and/or query one or more nodes on the blockchain storage 158 upon receiving a communication from any system or device described herein. In some implementations, the central node may be an token and may be the root node (e.g., the originally created token), and any additional nodes added may be attached (e.g., appended, pre-appended, linked, associated, embedded) to the central node via one or more communications networks (e.g., public, private, shared, and so on). In various implementations, the central node may be a dummy asset that stores data (e.g., addresses) to communicate with the other nodes on the blockchain storage 158.

Alternatively or in combination, the plurality of nodes on the blockchain storage 158 could be interconnected with the plurality of nodes to form a peer-to-peer network (e.g., distributed ledger network). In the following implementation, instead of a central node operating as an intermediary, each node may contain a copy of a plurality of tokens stored and maintained by the data processing system 102 and can operate as an individual intermediary which may contain a copy of a tokens stored and maintained by the data processing system 102. Additionally, each node could be configured to determine functions to perform (e.g., execute a smart contract, send public key, update token) based on communications. While various circuits, interfaces, and logic with particular functionality are shown, it should be understood that the blockchain storage 158 can include any number of circuits, interfaces, and logic for facilitating the functions described herein. For example, the activities of multiple circuits (or processors) may be combined as a single circuit and implemented on a single processing circuit, as additional circuits with additional functionality are included.

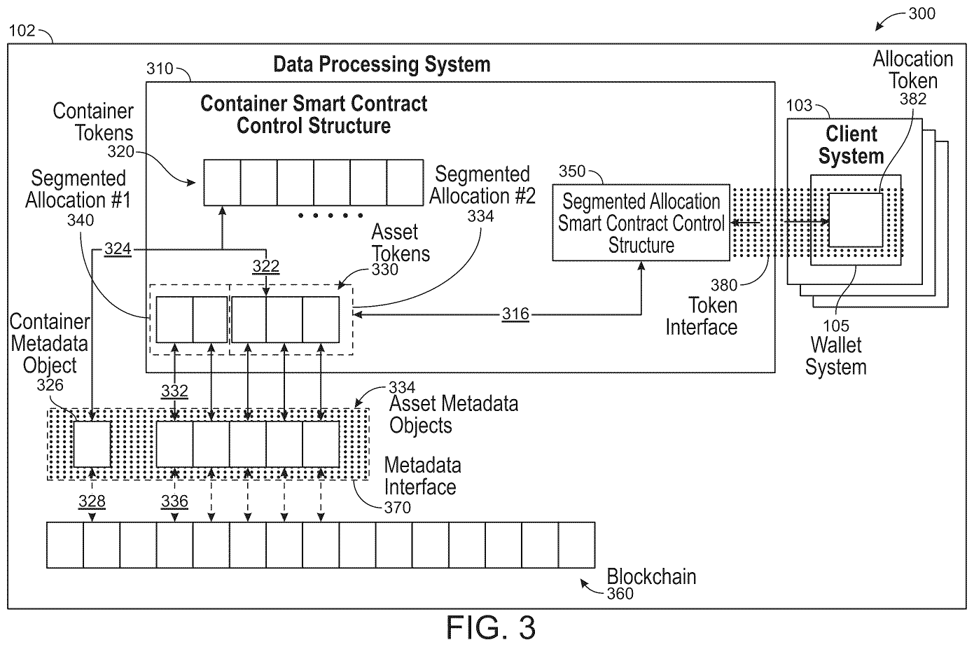

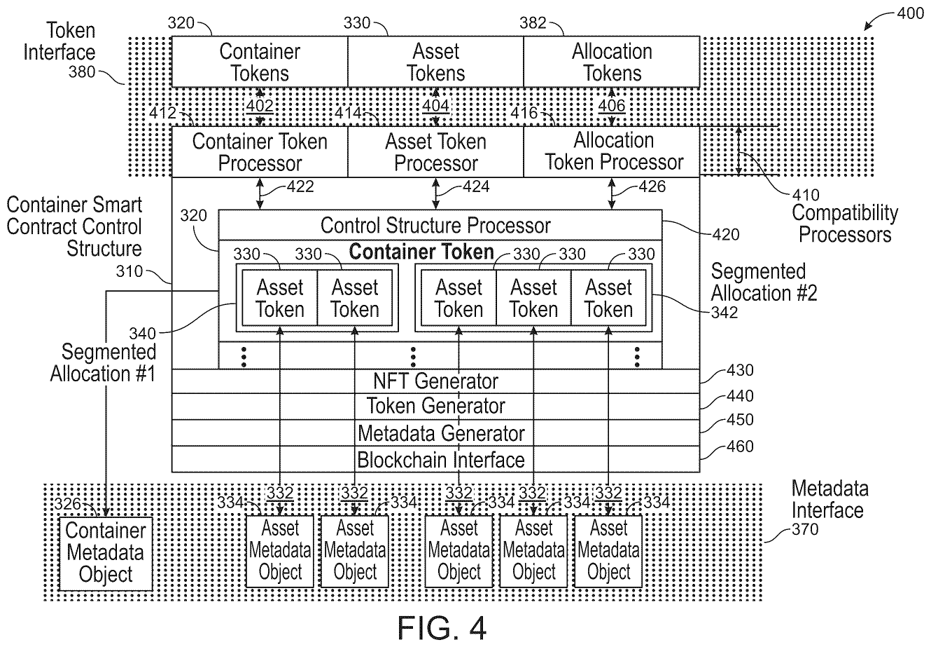

The data processing system 102 (in particular, interface controller 120) can be configured to process exchanges of tokens (e.g., withdrawal, deposit, update) and may be configured to perform various actions and/or access various types of data or metadata, some of which may be provide over network 101. In particular, the interface controller 120 can be configured to process token exchanges based on received public keys (or public and private key pairs, or private key), environmental data, off-chain data, and metadata of one or more tokens (e.g., fungible or non-fungible) stored by and on data processing system 102 (e.g., in 152, 154, and 158) from the systems and devices described herein. In some implementations, exchanges of tokens on-chain or off-chain include utilizing a control structure specific to the token or group of tokens (e.g., within a container). Although the FIGS. and specification generally discuss utilizing control structures on token exchanges and distributions (e.g., withdrawals, deposits, updates), the systems, methods, and apparatuses disclosed herein can also be used for a plurality of tokens such as, but not limited to, utility tokens, security tokens, payment tokens, exchange tokens, decentralized finance (DeFi) tokens, stablecoins, asset-backed tokens, privacy tokens, and so on. Additional details and examples relating to exchanging and restricting tokens or distributing underlying asset incomes or expenses of the tokens are described in detail with reference to FIGS. 3-4.

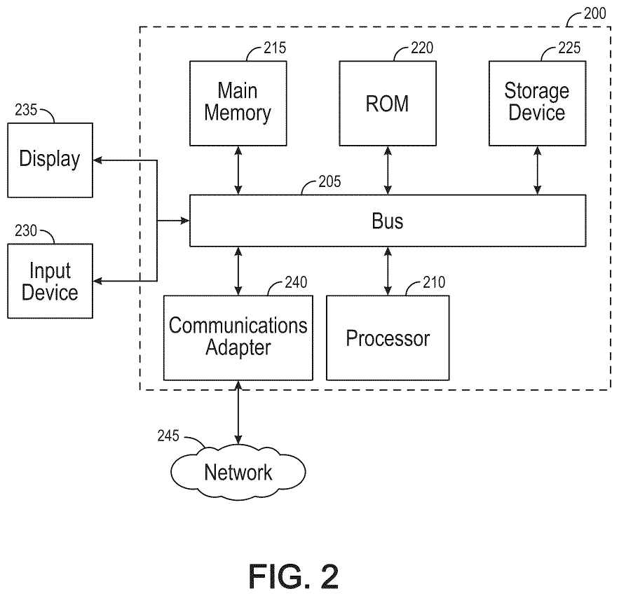

Referring now to FIG. 2, a depiction of a computer system 200 is shown. The computer system 200 that can be used, for example, to implement a computing environment (e.g., system 100), the data processing system 102, the client systems 103, the third-party devices 106, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In another arrangement, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to enable communications with a computing or communications network 245 (similar features and functionality as network 101) and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, virtual server. In various arrangements, computing system 200 may share physical storage, hardware, and other resources with other virtual machines. In some arrangements, virtual resources of the network may include cloud computing resources such that a virtual resource may rely on distributed processing across more than one physical processor, distributed memory, etc.

Referring now to FIG. 3, depicts an example data processing system 102 in system 300, in accordance with present implementations. As illustrated by way of example in FIG. 3, the data protection system 102 can utilize a blockchain 360 to log and verify exchanges involving container tokens 320 and asset tokens 330. This blockchain 360 can be a decentralized record, providing data consistency and immutability across networked transactions. Container tokens 320 can be structured within the container smart contract control structure 310. Each container token 320 encapsulates a plurality of asset tokens 330, with a specific linking mechanism, link 322, maintaining the association between the container tokens 320 and their respective asset tokens 330. These asset tokens 330, which may represent various financial securities like bonds or mortgages, can each linked via link 332 to an individual asset metadata object 334, which stores relevant data about the financial attributes and ownership records of the underlying assets.

As used herein, a “smart contract control structure,” “metadata control structure,” and “control structure” may be a computer program (also known as a program, software, software application, script, or code) configured to combine one or more attributes of the digital or physical asset together to create a single control structure for each metadata object (e.g., container metadata object 326, asset metadata objects 334). In some implementations, the data processing system 102 can implement and execute a control structure to output, append, or update metadata objects of one or more tokens (e.g., asset tokens, and container tokens) to include one or more metadata, attributes, and conditions (e.g., smart contracts), fields, a value, and so on. The control structure can be written in any form of programming language, including compiled or interpreted languages, and/or declarative or procedural languages, and it can be deployed in any form, including as a stand-alone program or as a circuit, component, subroutine, object, or other unit suitable for use in a computing environment. A metadata object may, but need not, correspond to a file in a file system. A metadata object can be stored in a portion of a file that holds other programs or data (e.g., one or more scripts stored in a markup language document), in a single file dedicated to a token in question, or in multiple coordinated files (e.g., files that store one or more subsystems, sub-programs, or portions of code). A control structure can be deployed to be executed on one computer or on multiple computers that are located at one site or distributed across multiple sites and interconnected by a communication network. The processes and logic flows described in this specification can be performed by one or more programmable processors executing one or more control structures (or computer programs) to perform actions by operating on input data (e.g., off-chain data, provenance requests, etc.).

As used herein, the phrase “smart contract” generally refers to a self-executing code (e.g., in a ledger network or other system) that executes when a set of conditions that have been agreed upon by the parties of the smart contract are met. Although the FIGS. and specification generally discuss utilizing smart contracts on tokens, the systems, methods, and apparatuses disclosed herein can also be used for a plurality of types of non-fungible or fungible assets, such as but not limited to commodities, common shares, options, dollar bills, fiat currency, digital currency, tokens, deeds, leases, wills, other exchanges, non-smart contracts, traditional legal contracts, financial disbursements, taxes, and other types of non-fungible or fungible assets parties use and exchange. Parties to the smart contract for tokens or other types of non-fungible or fungible assets may be individuals, companies, organizations, entities, providers, and so on.

While system 300 depicts the segmented allocation smart contract control structure 350 as internal to the container smart contract control structure 310, it should be understood that in some implementations it can be external from the container smart contract control structure 310. Additionally, in some implementations, it should also be understood that while FIG. 4 shows the segmented allocation smart contract control structure 350 internal to the container smart contract control structure 310, the controller structure processor 420 of FIG. 4, which manages the execution of these smart contracts, may be external to the container structures.

The data protection system 102 also can include a metadata interface 370 that facilitates communication between the blockchain 360 and both container metadata objects 326 and asset metadata objects 334. The metadata interface 370 can ensure that any updates or changes to the metadata are accurately and promptly reflected in the blockchain 360, maintaining data integrity and accuracy. Segmented allocations within each container token 320, such as segmented allocation 340 or segmented allocation 342, can be managed through the segmented allocation smart contract control structure 350. The segmented allocation smart contract control structure 350 can uses link 236 to connect with the container smart contract control structure 310, allowing for the dynamic adjustment of asset groupings within each container token 320 based on predefined parameters such as risk profiles or maturity dates. The adjustments can then recorded on the blockchain 360 via the metadata interface 370 in the container metadata object 326 (e.g., indicating the different segmented allocation the container token includes) and asset metadata objects 334 (e.g., indicating what segmented allocation the asset token is encapsulated in). Additionally, data protection system 102 can also include mechanisms for issuing allocation tokens 382 through a token interface 380 to a client system 103, which can be stored in a wallet system 105. The allocation tokens 382 can represent stakes or shares in particular segmented allocations, allowing token holders to receive returns based on the performance of the asset tokens 330 within these allocations.

In some implementations, a smart contract control structure, such as the container smart contract control structure 310 and the segmented allocation smart contract control structure 350, can be a framework built that automates the enforcement, management, and execution of agreements within the data protection system 102. These control structures can be programmed to execute specific functions when predetermined conditions are met. The container smart contract control structure 310 can manage operations related to the creation, modification, and interaction of container tokens 320, and the segmented allocation smart contract control structure 350 can manage the rules and conditions under which asset tokens 330—controllable electronic record—are grouped into segmented allocations within a container token 320 and rules or conditions on which an output to an allocation token 382 is necessitated.

In some implementations, a link (e.g., link 322, 324, 332, 336) can be a reference mechanism that connects tokens to either other tokens or metadata objects, establishing a navigable relationship between them. These links can be used to track and allow operational consistency across the data protection system 102. For example, link 322 connects asset tokens 330 to their respective container token 320, and link 332 can connect each asset token 330 to its specific asset metadata object 334, facilitating data retrieval and interaction based on blockchain 360's immutable record system.

In some implementations, a metadata object, such as a container metadata object 326 or an asset metadata object 334, can be a structured data entity that stores descriptive information about the characteristics and state of a token. This information can include, but is not limited to, ownership details, historical transaction data, and specific attributes related to the asset or container. For example, the asset metadata object 334 store hold data pertaining to a financial product the asset token 330 represents, such as its interest rate, maturity, or credit risk.

In some implementations, a segmented allocation, examples of which include segmented allocation 340 and 342, can be the subdivision of a container token's 320 asset tokens 330 into smaller, distinct groups based on specific criteria such as risk level, asset type, or maturity profile. These segmented allocations allow for the management of assets within a container, optimizing returns and risk distribution by aligning them with the investment strategies or requirements of the token holders. Each segmented allocation can be managed dynamically via the segmented allocation smart contract control structure 350, adapting to changes in market conditions or investor preferences.

In some implementations, a token such as a container token 320, asset token 330, or allocation token 382, can represent a digital asset or a right that can be traded, held, or used as part of a larger ecosystem of financial products and services. Tokens can be fungible, where each token is identical to others and interchangeable (like traditional currency), non-fungible (NFT), where each token has unique properties and is not interchangeable, or semi-fungible, combining aspects of both. For example, an asset token 330 could represent a specific bond within a financial market, while a container token 320 could encapsulate a diversified portfolio of such bonds, and an allocation token 382 could represent ownership or a claim to a part of the returns from a specific segmented allocation within a container.

The container tokens 320 can correspond to a particular metadata object or metadata objects, such as container metadata object 326. A container token 320 can digitally represent an asset on a blockchain and can serve as proof of ownership of or rights to a specific asset or pool of assets (e.g., pools of asset tokens 330, also referred to herein as controllable electronic records). The container token 320 can be verified by anyone on blockchain 360 and the token ensures authenticity of the asset or assets. Each container token can store a data value composed of at least a token identifier and a contract number. The token identifier can be a unique set of characters (e.g., numbers, symbols, and letters) uniquely identifying the specific container token. For example, token identifier #1 can be identified as “G8fNM64!”, and token identifier #2 can be identified as “lkj93IOs.” The contract number can be a unique set of characters (e.g., numbers, symbols, and letters) uniquely identifying the control structure (e.g., container smart contract control structure 310) used by the container token 320 in managing and executing the functionality such as restricting the container token 320, outputting from the container token 320, etc. For example, control structure #1 can be identified as “CS_00001”, and control structure #2 can be identified as “CS_00002.” Thus, the data value can be an aggregate of the two identifier, such as a cryptographic hash of the two identifiers (e.g., data value before hash “G8fNM64!CS_00001”, after hash “DFCD 3454 BBEA 778B 712A 652G 336F 90B1 7D9A 46AF”), or encrypted (e.g., using RSA encryption, AES encryption, SHA encryption, DES encryption). In some implementations, the data value can be the public key of the container token used to decrypt the container token and/or interface with the destination address on the blockchain or in a digital wallet. The asset token 330 can include similar features and functionality as the container token.

The processor or processing circuits of the data processing system 102 can execute one or more actions with respect to various cryptographic keys, tokens, containers, control structures, and smart contracts. For example, the data processing system 102 can modify links between various containers, control structures, tokens, and smart contracts with various public-private key pairs. The blockchain 360, within a blockchain storage, can include at least one blockchain including one or more of the blocks. The blockchain 360 can be linked with one or more metadata objects, tokens, and smart contract control structures. The blockchain 360 can include a blockchain operated and controlled at the data processing system 102. The blockchain 360 can include a plurality of blockchains each corresponding to particular aspects of the links associated with the corresponding blockchains. The data protection system 102 can include a blockchain 360—a decentralized ledger to record all transactions and interactions within the data protection system 102. The blockchain 360 can be used to provide transparency of data within the data protection system 102, reducing the risk of tampering and fraud. For example, when an exchange occurs involving any asset tokens 330, it can be immutably recorded on the blockchain 360, providing a verifiable and permanent record.

Within the data protection system 102, a container smart contract control structure 310 can manage container tokens 320, which may be either non-fungible tokens (NFTs) or fungible tokens. Each container token 320 can serve as a digital representation of a collection of asset tokens 330, which themselves can represent securities or exchange instruments such as bonds or mortgages. For example, a container token 320 could represent a diversified portfolio of mortgage-backed securities, each tokenized as asset tokens 330 (e.g., controllable electronic records).

Each container token 320 can link to its respective asset tokens 330 through a link 322. Link 322 can include a reference, pointer, or the like, to or between a container token 320 and a pooled set of asset tokens 330. Link 322 can be used to establish and maintains the relationship between a container token 320 and its contained asset tokens 330, providing that updates to the container token 320 accurately reflect changes in its associated assets. For example, if an asset token 330 within a container token 320 is sold or exchanged, link 322 ensures the container's composition and value are updated accordingly.

Asset tokens 330 within a container token 320 can be organized into segmented allocations, such as segmented allocation 340 or segmented allocation 342, based on specific parameters like security type, maturity date, interest rate, and remaining principal. The segmented allocations allow for customized strategies and management by creating sub-pools within a container token 320. For example, segmented allocation 340 may consist of high-risk, high-yield bonds, while segmented allocation 342 could include lower-risk, stable-income bonds.

Each asset token 330 can include a link 332 to an asset metadata object 334, which stores detailed information about the underlying asset, such as its financial attributes, ownership history, and performance data. The asset token 330 can be a controllable electronic record. Link 332 can include a reference, pointer, or the like, to or between an asset token 330 and an asset metadata object 334. Link 332 can be used to ensure that every asset token 330 has accessible, up-to-date information on its characteristics. For example, potential investors can examine the metadata to assess risk and potential returns before acquiring an asset token 330. Asset tokens 330 can each include a particular fungible or non-fungible token and can correspond to particular asset metadata objects 334. An asset token 330 can be associated with a particular asset metadata object, and can be required to transmit output of the metadata object, transfer the metadata object to another storage location, or any combination thereof, for example. Each of the asset token 330 can indicate control of a particular metadata object of the asset metadata objects 334 by a corresponding metadata link of the metadata links 332. The asset metadata objects 224 can each include a particular data or instructions. Metadata objects can correspond to a collections of executable instructions or data that can be finite. For example, a metadata object can include a video file corresponding to a limited number of instances of video metadata. For example, a metadata object can include an audio file corresponding to a limited number of instances of audio metadata. For example, a metadata object can include a metric that increases with limited capacity, such as a physical measurement a financial instrument valuation, a periodic output based on a physical or scarce property, or any combination thereof.

Similarly, each container token 320 can contain a link 324 to a container metadata object 326, which can store information about the container token's overall composition and performance. Link 324 can include a reference, pointer, or the like, to or between a container token 320 and a container metadata object 326. Link 324 can be used to provide aggregated performance and risk profile data of all assets held within the container token 320. For example, by accessing the container metadata object 326, investors can determine the diversity and health of the investments within a specific container token 320.

The metadata interface 370 can be a communication channel between the container tokens 320, asset tokens 330, and their respective metadata objects 326, 334. The metadata interface 370 facilitates the exchange of metadata information to the blockchain 360, via link 328 and link 336, such that all recorded data remains current and accurate. Link 328 can include a reference, pointer, or the like, to or between a container metadata object 326 and a block on blockchain 360. Link 336 can include a reference, pointer, or the like, to or between an asset metadata object 334 and a block on blockchain 360. For example, updates made to an asset metadata object 334 can be relayed or communicated via the metadata interface 370 to the blockchain 360, keeping the blockchain's records synchronized with real-world changes.

The segmented allocation smart contract control structure 350 can execute the creation and management of segmented allocations within a container token 320, using a link 236 to control outputs from the container smart contract control structure 310 based on metadata. The segmented allocation smart contract control structure 350 can restrict and specify the conditions under which asset tokens 330 are grouped or regrouped, affecting the distribution of cash flows from underlying assets. For example, the segmented allocation smart contract control structure 350 can dynamically alter segmented allocations in response to changes in market conditions or investor preferences.

The segmented allocation smart contract control structure 350 can also issue allocation tokens 382 through a token interface 380 to a client system 103, which can be stored in a wallet system 105. Allocation tokens 382 can represent ownership or investment in a particular segmented allocation, allowing investors to receive direct benefits from the cash flows generated by the underlying assets. For example, an investor holding an allocation token 382 for segmented allocation 340 could receive periodic payments derived from the income generated by the high-yield bonds within that allocation.

Sill referring to FIG. 3, the container smart contract control structure 310 can execute and manage the functions related to both the container tokens 320 and the asset tokens 330. The container smart contract control structure 310 can enforce the conditions under which data from the container metadata object 326 and the asset metadata objects 334 can be accessed and modified. The container smart contract control structure 310 can restricts outputs of the container metadata object 326 and asset metadata objects 334 by coded rules within the smart contract code of container smart contract control structure 310 that govern the release and modification of metadata-controlling the visibility and update permissions.

The segmented allocation smart contract control structure 350 can be employed in operationally managing how asset tokens 330 are grouped into specific allocations like segmented allocation 340 or 342 within a container token 320. The segmented allocation smart contract control structure 350 can use parameters defined within the smart contracts to evaluate asset tokens 330 based on their metadata, such as maturity dates or payment histories, to form tranches or pools that meet specific investment criteria. The segmented allocation smart contract control structure 350 can continuously monitor the metadata to verify that each asset token 330 remains compliant with the established criteria of a respective segmented allocation. For example, if an asset token no longer meets the requirements, the segmented allocation smart contract control structure 350 can trigger a re-segmentation, updating the composition of the segmented allocation and issuing new or revised allocation tokens 382 through the token interface 380. The allocation tokens 382 can be used to represent ownership or entitlements to the cash flows generated by the underlying assets, and are transferred to the wallet system 105 of client system 103.

The two control structures interact by leveraging the blockchain's capability to execute smart contracts automatically, using the data stored in metadata objects 334 and 326. The container smart contract control structure 310 can set the governance framework for how fungible and non-fungible assets (also referred to herein as “controllable electronic records”) are contained and categorized, and the segmented allocation smart contract control structure 350 can provide the mechanism for dynamically adjusting these categorizations based on real-time data assessments, ensuring the data processing system's 102 responsiveness to changes in asset performance and investor requirements. In some implementations, the outputs—exchanges and token adjustments—can be controlled and executed according to predefined rules embedded within the smart contracts.

In some implementations, the container smart contract control structure 310 and the segmented allocation smart contract control structure 350 can be implemented using a combination of hardware and software within the data processing system 102. Central Processing Units (CPUs) of the data processing system 102 can execute the smart contract logic, which is written in a programming language, compiled into bytecode, and deployed on blockchain 360. Memory storage of the data processing system 102 can store the current state for rapid access and updating during transaction processing, and persistent storage archives the complete history of all blockchain transactions. The various components can allow the container smart contract control structure 310 to manage access and modifications to metadata objects associated with container tokens 320 and asset tokens 330, and the segmented allocation smart contract control structure 350 can dynamically manage the grouping of asset tokens into segmented allocations (e.g., segmented allocations 340, 342) based on predefined criteria.

While FIG. 3 depicts a single container metadata object 326 linked (by link 324) to a single container token 320, and the single container token 320 is linked (by link 322) to asset tokens 330 with two segmented allocations (340 and 342), it should be understood that this representation is illustrative. In implementation, a plurality of container tokens 320 can each be linked to their own container metadata objects and connected to respective asset tokens, which may be grouped into various other respective allocations.

Still referring to FIG. 3, the segmented allocation smart contract control structure 350 can be programmed to automatically evaluate and assign asset tokens 330 into segmented allocations such as tranches (e.g., segmented allocations 340 or 342) based on specific parameters defined within the segmented allocation smart contract control structure 350. The parameters can include, but is not limited to, loan type, maturity date, interest rate, remaining principal, and payment performance indicators such as being less than 90-days delinquent, on-time payment status, and whether the payment is at or below the required minimum. The segmented allocation smart contract control structure 350 can dynamically assign asset tokens 330 to an appropriate segmented allocation by analyzing the metadata from asset metadata objects 334 that store these details for each asset token.

In some implementations, the segmented allocation smart contract control structure 350 assigns asset tokens 330 to appropriate segmented allocations by accessing metadata, which can be selectively made available under specific conditions enforced by the container smart contract control structure 310. This access can be facilitated through predefined permissions within the container smart contract control structure 310, allowing the segmented allocation smart contract control structure 350 to retrieve and utilize metadata that has been securely outputted and restricted by the container smart contract control structure 310. In some implementations, when the segmented allocation segmented allocation smart contract control structure 350 needs to access restricted metadata, it can execute a call to a function defined in the container smart contract control structure 310, which can check if the requesting contract has the necessary permissions and then conditionally releases the metadata based on the established security rules and validation criteria.

For example, when the segmented allocation smart contract control structure 350 needs to re-segment asset tokens 330 based on updated risk profiles, the segmented allocation smart contract control structure 350 can initiate a request to access updated credit metadata from the asset metadata objects 334, which are managed by the container smart contract control structure 310. The request could be structured as a function call, “getAssetMetadata(assetId)”, embedded within the segmented allocation smart contract control structure's 350 code. Upon receiving the request, the container smart contract control structure 310 can analyze it through a function “validateAccess(requestorId, assetId)”. This function can check if the requesting contract (identified by requestorId) has the permissions to access the metadata of the specified asset token (identified by assetId). If the validation passes, the requested metadata is provided, allowing the segmented allocation smart contract control structure 350 to proceed with the re-segmentation of the asset token 330 based on its current credit profile, thereby dynamically adjusting the allocation to reflect changes in the underlying asset conditions.

In some implementations, after the asset tokens 330 are grouped into a segmented allocation, the segmented allocation smart contract control structure 350 can then issues allocation tokens 382, which are transferred via a token interface 380 to the wallet system 105 of a client system 103. These allocation tokens 382 can represent the client's entitlement to receive cash flows generated from the underlying assets within the segmented allocation, and these distributions can be calculated based on the performance metrics of the underlying assets as recorded in the asset metadata objects 334. Additionally, the segmented allocation smart contract control structure 350 can continuously monitor the asset metadata to ensure that each asset token 330 within the segmented allocations (e.g., segmented allocations 340 and 342) continues to satisfy the initial criteria for segmentation. If any asset token 330 no longer satisfies the criteria due to changes in its performance metrics or other key parameters, the segmented allocation smart contract control structure 350 can trigger a process to re-segment these tokens. For example, the segmented allocation smart contract control structure 350 could recalculate the appropriate segmented allocation for the token and updating or reissuing the allocation tokens 382 accordingly.

The segmented allocation smart contract control structure 350 can utilize the allocation tokens 382 to manage and authorize specific actions. For example, an output of financial distributions or sensitive data from the asset tokens 330 may be contingent upon the presence of an allocation token 382, verified by the segmented allocation smart contract control structure 350. That is, the presence of the allocation token 382 can include validating the allocation token's 382 existence and its associated rights within a transaction or access request. When a request or distribution is made, the segmented allocation smart contract control structure 350 can check if the requester or user receiving a distribution holds a valid allocation token 382, verifying its authenticity and permissions encoded within the token.

Still referring to FIG. 3, the wallet system 105 can include one or more tokens and keys corresponding to a various accounts and linked with the client system 103. For example, the wallet system 105 can encapsulate one or more allocation tokens linked with the client system 103 within a secure container, and can include an interface compatible with the data processing system 102, the segmented allocation smart contract control structure 350, and the token interface 380. The wallet system 105 can include allocation tokens 382. The allocation tokens 382 can each include a particular token and can correspond to rights to a portion of asset tokens 330 of one or more segmented allocations in the container smart contract control structure 310.

The container smart contract control structure 310 can include one or more instructions to restrict and transmit output of one or more of the container tokens 320 and asset tokens 330. The container smart contract control structure 310 can correspond to an executable smart contract and can include a gateway component. The gateway component can include one or more instructions to restrict or prevent output of the container tokens 320 and asset tokens 330 in the absence of presence of a request or pull by the segmented allocation smart contract control structure 350 or receiving one or more tokens compatible with the container smart contract control structure 310. The smart contract control structure can include an encapsulation layer that (shown as container smart contract control structure 310), for example, maintains the tokens in an encrypted state. The container smart contract control structure 310 can permit access to the tokens based on a private key, for example, compatible with the encapsulation layer and operable to decrypt the encryption corresponding to the encapsulation layer. The gateway component can be compatible with and interface with the metadata interface 370, and the encapsulation layer can be integrated with the container smart contract control structure 310. The smart contract control structure 310 can be registered to the blockchain 360 by a block link with the blockchain 360.

FIG. 4 depicts an example container smart contract control structure 310 operated by processors of data processing system 102, in accordance with present implementations. As illustrated by way of example in FIG. 4, the processors of the container smart contract control structure 310 can include at least compatibility processors 410, control structure processor 420, NFT generator 430, token generator 440, metadata generator 450, and blockchain interface 460.

The compatibility processors 410, including the container token processor 412, asset token processor 414, and an allocation token processor 416, can detect a presence of a token (fungible, non-fungible, partially-fungible), and can transmit the token to a compatibility processor (e.g., 412, 414, 416) compatible with that particular token. The detection can be responsive to an action by the token interface 380 to transmit the tokens to the container smart contract control structure 310. The token interface 380 can include a communication channel between one or more of the container smart contract control structures 310, the tokens at the data processing system 102, and tokens at the client system 103. The token interface 380 can include an application programming interface compatible with the container smart contract control structure 310 to detect the secure tokens at the data processing system 102, and the tokens at the client system 103. At least the token interface 380 or the container smart contract control structure 310 can execute one or more instructions to determine whether one or more of the tokens are compatible with the container smart contract control structure 310.

The container token processor 412 can perform detection of container tokens 320 via link 402. The detection can be responsive to receiving a container token 320 from a token generator 112, client system 103, or third-party device 106, over link 402. The container token processor 412 can be configured to be compatible with a particular container token 320, or can be generated to be compatible with a particular container token 320. For example, the container token processor 412 can be integrated with or store a hash based on a container token 320 and a hash processor operable to generate a hash based on any container token 320. The container token processor 412 can generate a hash in response to detecting the presence of the container token 320, and can determine whether the container token 320 is compatible with the container smart contract control structure 310, in response generating the hash, by comparing the generated hash with the stored hash. The container token processor 412 can include logic to detect a container token 320 passed to it, by, for example, a JSON object or a header argument. Additionally, the container token processor 412 can provide the detected container token 320 to the control structure processor 420 via link 424.

The asset token processor 414 can perform detection of asset tokens 330 via link 404. The detection can be responsive to receiving an asset token 330 from a token generator 112, client system 103, or third-party device 106, over link 404. For example, the asset token processor 414 can be integrated with or store a hash based on an asset token 330 and a hash processor operable to generate a hash based on any asset token 330. The asset token processor 414 can generate a hash in response to detecting the presence of the asset token 330, and can determine whether the asset token 330 is compatible with the container smart contract control structure 310, in response generating the hash, by comparing the generated hash with the stored hash. The asset token processor 414 can include logic to detect an asset token 330 passed to it, by, for example, a JSON object or a header argument. Additionally, the asset token processor 414 can provide the detected asset token 330 to the control structure processor 420 via link 424.

The allocation token processor 416 can perform detection of allocation tokens 382 via link 406. The detection can be responsive to receiving an allocation token 382 from a token generator 112, client system 103, or third-party device 106, over link 406. For example, the allocation token processor 416 can be integrated with or store a hash based on an allocation token 382 and a hash processor operable to generate a hash based on any allocation token 382. The allocation token processor 416 can generate a hash in response to detecting the presence of the allocation token 382, and can determine whether the allocation token 382 is compatible with the container smart contract control structure 310, in response generating the hash, by comparing the generated hash with the stored hash. The allocation token processor 416 can include logic to detect an allocation token 382 passed to it, by, for example, a JSON object or a header argument. Additionally, the allocation token processor 416 can provide the detected allocation token 382 to the control structure processor 420 via link 426.

The container smart contract control structure 310 can include a control structure processor 420 configured to generate container tokens 320 including a plurality of pooled asset tokens 330. That is, responsive to receiving asset tokens 330 by the asset token processor 414, the control structure processor 420 can receive the asset tokens 330 via link 424. In some implementations, generating a container token 320 can include generating a container metadata object 326 including metadata of the plurality of asset tokens 330. For example, the container metadata object 326 can be generated by a metadata generator 450 as part of the metadata interface 370. The container metadata object 326 can include details such as ownership data, transaction history, and asset specifics.

In some implementations, the control structure processor 420 can generate a container token 320 including a link with the container metadata object 326. The link can be established via a digital signature or cryptographic hash that securely associates the container token 320 with its metadata. The container metadata object 326 can be provided to a metadata interface 370 such that a blockchain can verify and store the metadata securely on the chain. Additionally, the control structure processor 420 can encapsulate a container token 320 and a plurality of asset tokens 330 within the container smart contract control structure 310. Encapsulating can include encrypting the data and setting permissions for data access. That is, the encapsulation can restrict outputs of the container metadata object and the plurality of asset metadata objects. For example, when the container token 320 and plurality of asset tokens 330 are encapsulated, the control structure processor 420 may output when specific conditions or permissions are verified. In another example, when the container token 320 and plurality of asset tokens 330 are encapsulated, the control structure processor 420 may output when a valid decryption key is presented. Thus, the container token 320 can include pooled asset tokens 330 that are grouped based on similar investment profiles or risk categories. For example, the pooled asset tokens 330 can be a pooled set of securities (e.g., asset-backed securities, mortgage-backed securities, another pooled set of securities). In this example, the control structure processor 420 can manage access to and transactions involving these pooled securities. For example, it can authorize transactions only after verifying that all compliance and regulatory requirements are met.

The control structure processor 420 can also be configured to perform segmentation allocation of asset tokens 330 of a container token 320 based on parameters by accessing the metadata of the asset and container and evaluating their compliance with investment criteria. For example, it can assess the maturity date, interest rates, and credit risk of each asset token. In some implementations, the parameters can be defined based on market conditions and investor preferences. Accordingly, the control structure processor 420 can automatically pool (or tranche) asset tokens (associated with underlying assets) based on parameters. The parameters can be programmed into smart contracts of the control structure processor 420.

Additionally, the container token 320 (while one is shown, a container smart contract control structure 310 can include a plurality of container tokens 320, each with respective asset tokens 330) can include the asset tokens 330, each within at least one segmented allocation. For example, segmented allocation 340 could include two asset tokens, segmented allocation 342 could include three asset tokens. In some implementations, the segmented allocations 342 can be implemented by a segmented allocation smart contract control structure 350, described in detail with reference to FIG. 3. While not shown in FIG. 4, the segmented allocation smart contract control structure 350 can be within the container smart contract control structure 310 and operated by the control structure processor 420. For example, the integration allows for automated re-segmentation based on real-time data analysis. In another example, the integration allows for compliance checks and performance tracking without external system intervention.

Each of the asset tokens 330 of their respective segmented allocations can include asset metadata objects 332. Links 332 can connect each asset token 330 to its specific asset metadata object 334, facilitating data retrieval and interaction based on blockchain 360's immutable record system, using the metadata interface 370. The metadata interface 370 can include a communication channel between one or more of the tokens in the container smart contract control structure 310 and metadata objects of blockchain 360. That is, metadata objects (e.g., container metadata objects 326 and asset metadata objects 334) can be accessed and verified through blockchain transactions to ensure their integrity and authenticity. Furthermore, blockchain 360 can store links to the metadata objects or store the metadata objects in blocks of the blockchain. For example, this blockchain storage provides a decentralized and secure means of maintaining and accessing records. In another example, this ensures that all participants have consistent and unalterable access to the asset information. The token interface 380 can include an application programming interface compatible with the container smart contract control structure 310 to detect the secure tokens at the data processing system 102, and the tokens at the client system 103. At least the token interface 380 or the container smart contract control structure 310 can execute one or more instructions to determine whether one or more of the tokens are compatible with the container smart contract control structure 310.

The control structure processor 420 can further be configured to generate an allocation token 382 compatible with a segmented allocation control structure restricting outputs by the container of a first segmented allocation (e.g., segmented allocation 340) of the plurality of asset tokens 330 based on metadata of a subset of the plurality of asset metadata objects. The segmented allocation can be determined from parameters such as risk assessments and investment thresholds. This can create a tranche or financial pool where investments can be grouped based on their risk and return profiles. In some implementations, the segmented allocation smart contract control structure 350 of FIG. 3 can implement the segment allocation and generation of the allocation token 382. Additionally, the control structure processor 420 can monitor outputs including one or more performance metrics of the metadata of the subset of the plurality of asset metadata objects 334 of the first segmented allocation. That is, the metadata of the subset of the plurality of asset metadata objects includes underlying physical asset information. For example, the underlying physical asset information could be, but is not limited to, property details, loan performance, and borrower creditworthiness. In some implementations, the control structure processor 420 can determine an allocation distribution corresponding to the allocation token based on the one or more performance metrics of the first segmented allocation. For example, this distribution calculation can include apportioning returns to token holders based on the current value and performance of the underlying assets. In another example, this could include adjusting the distribution rates in response to changes in asset conditions or market dynamics.

The control structure processor 420, responsive to determining the allocation distribution can either (1) automatically initiate an on-chain exchange of the allocation distribution from an instrument owner's wallet address to a mobile wallet address of the client system, wherein the instrument owner's wallet address corresponds to an instrument owner with a security interest in one or more underlying physical assets of the first segmented allocation of the plurality of asset tokens or (2) automatically process an off-chain exchange from the instrument owner's wallet address to an account of a user operating the client system. For example, the on-chain exchange can be conducted using blockchain technology to provide transparency. In another example, the off-chain exchange could be conducted through traditional banking channels.

The NFT generator 430 can generate one or more NFTs in accordance with a token obtained at the compatibility processors 410. For example, the NFT generator 430 can generate a container NFT based on a number of asset NFTs. For example, the NFT generator 430 can generate one or more asset NFTs 330 (e.g., controllable electronic records) each including a link or a reference to the container NFT 320 to identify a source NFT corresponding to the NFT minted by the NFT generator 430. For example, the NFT generator 430 can generate one or more NFTs each including a link or a reference to an NFT from which the new NFTs are minted. Thus, the NFT generator can provide a technical improvement of validating a minting of an NFT based on a provenance parameter embedded in the NFT. The provenance parameter can include a hash of the container NFT 320 or the NFT from which the new NFTs are minted, for example. Generating an NFT and minting an NFT can be used interchangeably.

The token generator 440 can generate one or more tokens (e.g., fungible or semi-fungible container tokens, asset tokens, and allocation tokens-collectively referred to herein as “controllable electronic records”) in accordance with a token obtained at the compatibility processors 410. For example, the token generator 440 can generate tokens based on a number of new metadata objects or NFTs indicated by an obtained token, and linked with respective smart contract control structures. For example, the token generator 440 can generate one or more tokens each linked with a particular smart contract control structure 310 or 350 with which the respective token is compatible. The token generator 440 can thus generate a corresponding number of keys that can control restrictions on output by the particular metadata object linked with the particular smart contract control structure compatible with the particular token. The token generator 440 can modify and delete tokens linked with container tokens, to update control of a partial distribution or exchange of metadata object control. For example, the token generator 440 can create an allocation token 382 controlling 25% of shares of a financial equity in a segmented allocation of asset tokens 330, and modify a token originally controlling 100% of the financial equity to link with a transformed smart contract control structure controlling 75% of the financial equity. The token generator 440 can make the modification in accordance with an example for a change in control of 25% of a financial equity controlled by the original token holder.

The metadata generator 450 can generate one or more metadata objects in accordance with a token obtained at the compatibility processors 410. For example, metadata generator 550 can generate multiple tokens based on a number of new metadata objects or tokens indicated by an obtained token, and linked with respective smart contract control structures. For example, the metadata generator 450 can generate one or more metadata objects each linked with a particular smart contract control structure 310 and 350 by which the respective metadata object is controlled. The metadata generator 450 can modify and delete metadata objects linked with tokens or smart contract control structures, to update control of a partial transfer of metadata object control.

The metadata generator 450 can modify a quantitative value corresponding to a token. For example, a quantitative value corresponding to a token can indicate a value of fiat currency or MBC currency. The metadata generator 450 can modify the quantitative value of the token based on a determined value (such as from off-chain data) to generate a scaled quantitative value. For example, a token having a quantitative value of 10,000 denominated in USD can be scaled based on a determined value of 0.1 to 1,000. The token scaler can perform any linear or linear transformation on a quantitative value.

The blockchain interface 460 can include an API compatible with the blockchain 260 via metadata interface 370. The blockchain interface 460 can selectively add, modify, and delete blocks from the blockchain 260. The blockchain interface 460 can add, modify, and delete blocks in accordance with restrictions or interfaces of the blockchain 260, and can add, modify, and delete blocks independently of the restrictions or interfaces of the blockchain 260 at any portion or index of the blockchain 260.

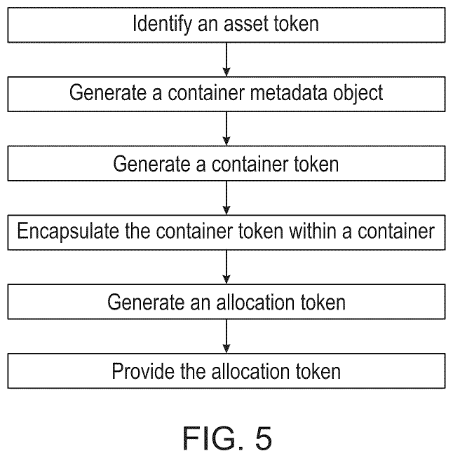

Referring now to FIG. 5, a flowchart for a method 500 to protect tokens using a protection architecture in accordance with present implementations. At least one of the example systems 100 and 300, or the example structures 400, can perform method 500 according to present implementations.

In broad overview of method 500, at block 510, the one or more processors (e.g., data processing system 102) can identify an asset token. At block 520, the one or more processors can generate a container metadata object. At block 530, the one or more processors can generate a container token. At block 540, the one or more processors can encapsulate the container token within a container. At block 550, the one or more processors can generate an allocation token. At block 560, the one or more processors can provide the allocation token. Additional, fewer, or different operations may be performed depending on the particular implementation. In some embodiments, some, or all operations of method 500 may be performed by one or more processors executing on one or more computing devices, systems, or servers. In various embodiments, each operation may be re-ordered, added, removed, or repeated. Additionally, some or all of the operations performed by the blocks may be removed or added based on the type of token received (e.g., fungible, non-fungible, or partially fungible). For example, in some implementations, the encapsulation in block 550 may be skipped when an allocation token was already provided to a client system.

Generally, the processing circuits of method 500 can implement the automatic creation of tranches via detection of certain conditions (e.g., default rates, payment history) using fungible tokens. For example, the assets may be asset-backed securities, mortgage-backed securities, or another pooled set of securities. In typical operation, assets (e.g., corporate bonds, municipal bonds) can be provided, which may be bonds or another type of asset and a servicer can be paid to collect cash flows based on the assets. In these operations, a trustee can track who owns what and whether the asset (e.g., bond) is meeting certain conditions (e.g., interest payments, collateral performance). When conditions are met, they pull the asset out. For example, a mortgage may be 90-day delinquent, and the trustee/system removes that mortgage when it hits that mark. Instead, the processing circuits can pool assets and individual assets can be minted into a NFT (or another token) for the pool and individual NFTs (or other tokens) representing the individual assets. This can create an immutable data trail (e.g., transaction history, ownership records). In some implementations, the processing circuits can actively monitor the pooled asset NFT and the individual asset NFTs. For example, there may be a plurality of pooled asset NFTs that each have individual asset NFTs (e.g., each representing different segments of the pool). In some implementations, the processing circuits may receive various predefined tranche characteristics, such as a loan type, a maturity date, an interest rate, a remaining principal, and so on. For example, regarding mortgage-backed securities, one trigger condition may be whether the customer is paying the mortgage. If yes, the processing circuits can classify it into one tranche; and if not, the processing circuits classify it into another tranche. Furthermore, tranching may be broken down into more granularity as well, such as if the consumer is paying more than the required minimum or less than the required minimum may lead to different tranche classifications (e.g., risk-based pricing adjustments). For example, as the individual assets are monitored, conditions of the individual assets may be identified (e.g., the dynamic remaining principal amount, changing interest rates, etc.). In some implementations, based on the characteristics of the individual assets, the processing circuits may tranche the individual assets. For example, the tranche creation may be specific to the already-pooled asset. In another example, the tranche creation may be done via individual assets across a plurality of pooled assets. In some implementations, the tranche creation may be dynamic in nature (e.g., adjusting to market fluctuations, regulatory changes) to reflect the changing characteristics of the individual assets. Furthermore, the NFT characteristic of the individual assets provides immutable tracking of the assets. In some implementations, the generated tranches may be provided for sale. If not sold, the generated tranches may be re-evaluated by the processing circuits repeatedly until the securitization of the tranche is enabled. This has the advantage of continuously working in order to promote a sale.

Referring to method 500 in greater detail, at block 510, the one or more processors (e.g., data processing system 102) identify a plurality of asset tokens (e.g., asset non-fungible token (ANFT), or asset fungible token (AFT)) including links to a plurality of asset metadata objects. In some implementations, the asset tokens can digitally represent an asset. In some implementations, the token is at least one of a fungible token or a non-fungible token (NFT). As used herein, an “asset” can be a representation of, but not limited to, a physical asset or a plurality of physical assets, a good or plurality of goods, a service or a plurality of services, name, image, or likeness (NIL) characteristics of an individual or group of individuals, or a combination of thereof. In some implementations, the processors can identify asset tokens (e.g., controllable electronic records) by scanning digital records or blockchain entries. For example, the metadata can be asset-backed security information, such as, but not limited to, bond type, owner, maturity date, interest rate, whether the asset is meeting certain conditions, such as delinquency or remaining principal. Additionally, the asset metadata objects can be dynamically updated as asset conditions change. For example, this metadata can be updated through periodic blockchain transactions that reflect current asset status.

At block 520, the processors (e.g., data processing system 102) can generate a container metadata object including metadata of the plurality of asset tokens-controllable electronic records. For example, the container metadata object can include records of each asset token's financial status, ownership, and transaction history. In some implementations, generating can include compiling data from various sources into a standardized format. Furthermore, generating the container metadata object can include a link to metadata objects of the plurality of asset tokens. For example, this link could include a pointer. That is, the link can be used to security access to asset token data. Furthermore, the container metadata object can be stored on a blockchain. In some arrangements, a block on the blockchain could store the container metadata object or have a link or pointer to an external data source. For example, the blockchain block could include a link to the smart contract control structure that manages access and updates to the container metadata object. In another example, the blockchain block could store the smart contract control structure that manages access and updates to the container metadata object.

At block 530, the processors (e.g., data processing system 102) can generate a container token (e.g., container non-fungible token (CNFT), or container fungible token (CFT)) including a link with the container metadata object. The container token can include similar features and functionality as the asset token described above. For example, generating the container token includes minting the token using a blockchain that encapsulates the metadata link. In some implementations, generating is the process of creating digital certificates for the token, where each certificate corresponds to an ownership claim or other rights associated with the container. In some implementations, the link to the container metadata object includes a unique identifier that corresponds to the blockchain record of the metadata object. For example, since the container metadata object can be linked or stored to a blockchain block, the processors can use the blockchain to identify updates or access attempts to the token's metadata. Additionally, the container token can further be encapsulated within a control structure (e.g., container smart contract control structure 310) that enables token-gated access.

At block 540, the processors (e.g., data processing system 102) can encapsulate the container token and the plurality of asset tokens within a container including a container control structure restricting outputs of the container metadata object and the plurality of asset metadata objects. Generally, encapsulating can include securing the tokens and their metadata. For example, the encapsulation process could include applying encryption techniques to the data. That is, encapsulating can ensure that sensitive information remains accessible only to authorized parties. In some implementations, the container can be a digitally secured environment and encapsulating the container where the container control structure restricts outputs includes applying access control rules and monitoring interactions with the token data. For example, restricting outputs can be related to controlling who can access metadata of the asset tokens or container tokens. In some implementations, the container control structure can be a set of smart contracts that manage access rights and data integrity.

In some implementations, the one or more processors can hash (e.g., SHA1, MD5, etc.), using a cryptographic hash or another math-based function, the control structure (or contract number) to create a digital signature of the control structure which can be stored in smart contract storage 156. The cryptographic hash of the control structure can be incorporated into segmented allocations to restrict functionality of the container tokens of the segmented allocation and increase security of the container token as an exchange or disbursement with a container token or segmented allocation of container tokens (e.g., output of fungible value or non-fungible value via a token or currency transfer) includes knowledge or access to the asset token prior to amending and/or updating the container token or blockchain. In some implementations, the one or more processors can hash (e.g., SHA1, MD5, etc.), using a cryptographic hash or another math-based function, the container token to create a digital signature of the container token which can be stored in blockchain storage 158. The cryptographic hash of the container token can allow users and system described herein to receive container tokens and verify them prior to amending and/or updating the container token or blockchain.

In some implementations, the container token and the plurality of asset tokens can be encapsulated within a container control structure that restricts an output of the metadata objects. In some implementations, the one or more processors can be further configured to generate a control structure (e.g., container smart contract control structure 310) based on the attributes, wherein the control structure is stored as at least one of a smart contract, or in a block on an internal ledger (e.g., blockchain 260). In some implementations, one or more control structures can be generated based on the attributes that are executable to restrict output of one or more particular metadata objects. The control structure can restrict access to the metadata object within the control structure, by an encapsulation layer that, for example, encrypts all metadata objects within the control structure with a common encryption scheme. The encapsulation layer can control output of multiple metadata objects within the control structure by uniformly and concurrently decrypting the metadata objects according to the common encryption scheme. Therefore, by using tokens with particular control structures, aspects of this technical solution can eliminate the exposure of sensitive/protected data in computer networked environments or digital wallets, which is an improvement over other asset and data protection architectures. This not only protects sensitive and protected assets and other data from compromise, but also protects entities from exposure, which is a significant improvement to the security of computing systems.

At block 550, the processors (e.g., data processing system 102) can generate an allocation token compatible with a segmented allocation control structure restricting outputs by the container of a first segmented allocation of the plurality of asset NFTs based on metadata of a subset of the plurality of asset metadata objects. The generation of an allocation token can include creating a digital token that encapsulates rights to receive distributions based on asset performance. That is, the allocation token can be an investor's right to the trustee. For example, the allocation token might specify terms under which distributions are made. In another example, the token could provide details on dividend schedules. In some implementations, being compatible with the segmented allocation control structure can include matching cryptographic signatures between the token and the control structure. That is, compatibility can include ensuring that the token's is accessible and can be monitored by the segmented allocation control structure. For example, this could include confirming that the token's metadata is properly formatted for the segmented allocation control structure. Additionally, restricting outputs by the container can include limiting data flows to authorized transactions. For example, this could include setting permissions that restrict how data is shared within or external the system.

Generally, the container smart contract control structure 310 is employed to create, validate, and encapsulate container tokens and their associated metadata (including asset tokens). The container smart contract control structure 310 can ensure that the container tokens adhere to predefined criteria and securely stores metadata on the blockchain. The segmented allocation smart contract control structure 350 can be employed in the segregation of asset tokens into different financial pools or tranches based on parameters such as risk, maturity, and yield, which can be derived from the asset metadata managed by the container smart contract control structure 310. The segmented allocation smart contract control structure 350 can be used to dynamically adjust the composition of these tranches in response to changes in the metadata or external market conditions. The container smart contract control structure 310 can provide the metadata and token access, and the segmented allocation structure uses this information to reallocate tokens.

In some implementations, a container token or one of the plurality of asset tokens (e.g., segmented allocations) can be encapsulated within a segmented allocation control structure that restricts an output of detailed financial information and performance metrics. In some implementations, the one or more processors can be further configured to generate a control structure (e.g., segmented allocation smart contract control structure 350) based on risk assessment and investment criteria, wherein the control structure is stored as at least one of a smart contract, or in a block on an internal ledger (e.g., blockchain 260). In some implementations, one or more control structures can be generated based on parameters such as asset type, risk profile, and maturity that are executable to restrict output by the container of a segmented allocation based on metadata objects (e.g., distributions, dividends, cashflows, etc.). The segmented allocation control structure can restrict access to sensitive transaction data and historical performance records, by an encapsulation layer that applies cryptographic measures. The encapsulation layer can control outputs by applying dynamic access controls based on user credentials and transaction context.

Referring to the interaction between the container smart contract control structure 310 and the segmented allocation smart contract control structure 350, the processing circuits can execute smart contract code that governs data flow between the two control structures. The smart contract code can facilitate the verification and validation processes for data exchange, utilizing smart contract functions that check compliance with defined access rules and parameters before allowing data outputs. For example, before releasing any financial outputs or asset metadata from the container control structure 310 to the segmented allocation control structure 350, the processing circuits can determine whether the requesting party meets the security criteria set within the smart contracts. In some implementations, smart contract code can be programmable logic embedded within blockchain transactions, defining and automating the terms of agreement directly within the codebase. For example, smart contract code can be compiled into bytecode, which can then deployed to the blockchain and executed by the Ethereum Virtual Machine (EVM) or other blockchain virtual machines. This code can be immutable once deployed (e.g., it cannot be altered) ensuring reliability and trust in the automated processes it governs. Execution of this code can be triggered by transactions or events that meet specific conditions defined within the contract itself. The smart contract code can be deployed to perform functions such as validating input data, executing predefined rules, managing data access, and automatically updating or transferring digital assets based on contract stipulations. Each execution can be a transaction that is validated by the network, recorded on the blockchain, and can require a transaction fee (or “gas” in Ethereum) that compensates for the computational resources used.

For example, in a blockchain system where a container smart contract control structure manages a broader collection of dividend-yielding stocks grouped into a single container token. This structure can be programmed functions like checkPermissions( ) and validateRequest( ) that restrict access to the data and operations associated with the stocks. These functions can ensure that attempts to access or distribute dividends undergoes validation against the contract's rules, such as verifying user credentials and confirming that the distribution conditions have been met. In this example, within the container, the segmented allocation smart contract control structure can specifically manage a tranche—a segmented allocation of financial instruments (e.g., stocks, bonds, mortgages) selected for their similar dividend profiles or market behaviors. The segmented allocation smart contract control structure can interact with the container control structure through function calls like requestDividendData( ) which triggers the container control structure's validateRequest( ) function to ensure proper authorization. Once validated, the container control structure allows the segmented allocation structure to access the dividend data. In this example, the segmented allocation control structure can then calculate dividends based on this data using a function like calculateDividends( ), which can aggregate total dividends from the tranche's assets and apportions them according to each token holder's share. The distribution of these dividends can then managed by another function, distributeDividends( ), which executes the payment transactions to token holders' wallets. In some examples, the dividend may occur only after another round of validation checks by the container structure's checkPermissions( ) function to ensure all conditions for distribution are still valid at the time of transfer.

In the above example, the communications and executions between the container smart contract control structure 310 and the segmented allocation smart contract control structure 350 can be further shown during the process of re-segmenting asset tokens within a tranche. As used herein, a “tranche” refers to a specific grouping of assets, segmented based on certain criteria such as maturity or credit quality, each being representable by unique or shared tokens within a blockchain system. This structured segmentation provides differentiable management and distribution strategies, customized to the specific characteristics and factors associated with each group. This re-segmentation can be done, for example, when there is a need to update the risk profiles of assets based on changes in their credit metadata. Re-segmenting can occur when the segmented allocation smart contract control structure 350 identifies a need to adjust the composition of a tranche due to updated risk assessments. It can initiate a secure request to access the latest credit metadata for specific asset tokens, using a function embedded within its code: getAssetMetadata(assetId). This function call can be directed to the container smart contract control structure 310, which can hold and manage the metadata of all asset tokens within the container. Upon receiving this request, the container smart contract control structure 310 can execute its validateAccess(requestorId, assetId) function to analyze the request. This function can check whether the requesting entity, identified by requestorId, has the permissions to access the detailed metadata for the asset token specified by assetId. If the request meets all security and compliance thresholds, the container control structure then can grant access to the required metadata. Once access is approved, the segmented allocation smart contract control structure 350 can retrieve the metadata and proceeds with recalculating the allocation of asset tokens within its tranche. This recalibration can be based on the newly accessed credit profiles, providing tranches that accurately reflect current financial risks and conditions. The updated allocation can then be communicated back to investors through changes in their allocation tokens, which can represent their shares and rights to dividends within the new configuration.

In some implementations, the allocation tokens can be generated in response to the processors generating, by the segmented allocation control structure (e.g., 350), a plurality of segmented allocations within the container based on an output of the container control structure corresponding to access to the plurality of asset metadata objects. That is, generating the plurality of segmented allocations can include applying a plurality of parameters to segment the plurality of asset tokens encapsulated within the container. For example, the segmentation might be based on asset type, risk level, or market sector. In another example, the segmentation could adjust dynamically in response to market conditions. Furthermore, the plurality of parameters can be, but is not limited to, financial metrics, regulatory compliance requirements, and investor preference profiles.

In another example, a segmented allocation control structure (e.g., 350) can facilitate the creation of tranches based on varying credit ratings and maturity periods of bonds within a large fixed-income portfolio. The segmented allocation control structure would apply parameters such as credit score thresholds (e.g., AAA, AA, A) and maturity ranges (e.g., short-term up to 2 years, medium-term 2 to 10 years, long-term over 10 years) to segment the asset tokens. Each tranche could then be represented by a distinct set of allocation tokens, reflecting the risk and return profile associated with its specific credit and maturity characteristics. The tranching approach can provide investors the option select a tranche that best matches their risk tolerance or investment horizon.

In some implementations, each allocation token can correspond to a proportional share of the tranche or pool of financial assets, entitling the holder to receive compensation or another type of distribution based on the quantity of tokens they own. The processing circuits executing the segmented allocation control structure can execute smart contract functions such as validateTokenOwnership( ) which can check and confirm that the request for dividends comes from a valid token holder. This function can ensure that only authenticated token holders can claim dividends. Once ownership is verified, the distributeDividends( ) function can be called to transfer the calculated dividend amounts directly to the token holders' blockchain wallets, using the details stored within each allocation token to execute and record the transaction securely on the blockchain. Moreover, the allocation tokens can be dynamically monitored through smart contract functions like updateTokenStatus( ), which can adjust token records and rights in response to changes in ownership or tranche adjustments.

In some implementations, the first segmented allocation can include a first plurality of the plurality of asset tokens satisfying a first set of the plurality of parameters, and a second segmented allocation can include a second plurality of the plurality of asset tokens satisfying a second set of the plurality of parameters. For example, the first set of the plurality of parameters could be risk tolerance levels, investment time horizons, and expected returns. In this example, the first segmented allocation could be a risk adverse allocation corresponding with a 10% interest a month. In another example, the second set of the plurality of parameters could be directed to liquidity requirements, currency exposure, and geographical diversification. In this example, the first segmented allocation could be a risky allocation corresponding with a 20% interest a month. That is, for an asset token to satisfy a parameter the processors can determine if the asset's characteristics align with the specified investment criteria. In some implementations, the first set is exclusive from the second set such that if an asset token satisfies the first set it may not satisfy the second set.

At block 560, the processors can provide, by the segmented allocation control structure to a client system, the allocation token. In some implementations, providing can be to the wallet system of the client system such that the allocation token is securely transmitted and stored. That is, the allocation token can be stored in a blockchain-based wallet. In some implementations, the processors can request and monitor, by the segmented allocation control structure, the outputs of the container control structure. In some implementations, the request can be for periodic updates on asset performance. For example, these updates could be provided daily, monthly, or quarterly. The outputs can include the metadata of the subset of the plurality of asset metadata objects of the first segmented allocation. For example, outputs can be monitored by the processors executing code that track changes in asset conditions. That is, monitoring can include verifying the accuracy and timeliness of data provided.

Furthermore, at or after block 560, the processing circuits (e.g., data processing system 102) can request and monitor, by the segmented allocation smart contract control structure, the outputs of the container control structure. That is, the outputs can include one or more performance metrics of the metadata of the subset of the plurality of asset metadata objects of the first segmented allocation, wherein the metadata of the subset of the plurality of asset metadata objects includes underlying physical asset information. In some implementations, the request can be initiated through a secure API call. For example, the API call may establish permissions for ongoing monitoring of the asset valuation data. In some implementations, the request to monitor outputs of the container control structure can be initiated through the secure API call. For example, this API call might request access to a continuous data stream that provides real-time updates on the status and performance of assets within the container control structure. The API could be configured to subscribe to event logs generated by the container control structure, which detail changes in asset valuations, transaction statuses, and updates to the metadata of the assets. In some implementations, the monitoring can be initiated through a secure API call. For example, the API call may request to monitor real-time or the latest valuation data for the assets. In some implementations, monitoring can include tracking changes in the asset valuations in real-time (or near real-time or periodically). For example, monitoring could include using event listeners to detect when updates to asset metadata are committed to the blockchain. For example, the event listeners can execute callback functions that process or record these changes. That is, an event listener can automate responses such as triggering alerts or updating related data fields across the system. Additionally, the event listeners can log these events for audit and compliance purposes, ensuring that all changes are documented and verifiable. Additionally, the outputs including the performance metrics can include details such as current market value, depreciation, and yield rates. For example, the outputs might specify exact financial figures. In another example, the outputs could also include historical performance trends for comparison.

In some implementations, the segmented allocation control structure can utilize event listeners to dynamically track and respond to changes within the container control structure. Specifically, these event listeners can be configured to monitor a variety of event logs emitted by the container control structure, such as updates in asset valuations or changes in transaction statuses. For example, when an asset within the container undergoes a valuation update (e.g., a process triggered by market fluctuations or asset performance) where the change is captured in an event log generated by the container control structure. The event listener, having subscribed to these specific types of logs, can detect the update and automatically trigger a predefined API call, such as getAssetMetadata(assetId). This call can retrieve the updated metadata for further processing. The API can be implemented to interact directly with the blockchain's secure interface. In some implementations, polling mechanisms can be employed as an alternative or in combination to event listeners. For example, polling can include periodically querying the blockchain or database to check for updates or changes in the asset metadata, such that the processing circuits can process new information on a scheduled basis. In some implementations, webhooks can also be used where the blockchain system can push notifications directly to the application when specific events occur.

Furthermore, at or after block 560, the processing circuits can determine an allocation distribution corresponding to the allocation token based on the one or more performance metrics of the first segmented allocation. In some implementations, the determination of the allocation distribution can include calculating proportional shares based on the token holdings and the performance metrics. For example, the distribution might factor in the recent market upturns or downturns affecting asset values. That is, the allocation token can represent a quantified claim on the forthcoming distribution. For example, it could denote the percentage of the profit each token holder is entitled to based on their token ownership.

Furthermore, at or after block 560, the processing circuits can in response to determining the allocation distribution, either (1) automatically initiate an on-chain exchange of the allocation distribution from an instrument owner's wallet address to a mobile wallet address of the client system, wherein the instrument owner's wallet address corresponds to an instrument owner with a security interest in one or more underlying physical assets of the first segmented allocation of the plurality of asset tokens or (2) automatically process an off-chain exchange from the instrument owner's wallet address to an account of a user operating the client system. In some implementations, automatically initiating can include generating a transaction on the blockchain. That is, the blockchain transaction would transfer the designated amounts to the respective wallets. For example, this could include broadcasting the transaction to network nodes for verification and completion. In another example, details of the transaction such as time-stamped logs could be appended for auditability. In some implementations, automatically processing can include interfacing with banking or provider systems to execute electronic fund transfers. That is, the transfer could be completed using financial protocols. For example, it could include converting the blockchain-based values into fiat currency amounts as per current exchange rates. In another example, notifications of the transaction completion could be sent to the relevant parties via an integrated messaging system.

Additionally, the processors can determine at least one of the plurality of asset tokens of the first segmented allocation conflicts with a first set of the plurality of parameters. In some implementations, a conflict can be identified based on monitoring market trends and regulatory updates. For example, if an asset falls below compliance thresholds, it could trigger a review. In another example, if asset performance significantly deviates from projections, it might prompt a reassessment of the allocation. In some implementations, the processors can generate an updated allocation token compatible with the segmented allocation control structure restricting the output by the container of an updated allocation token of the plurality of asset tokens based on metadata of an updated subset of the plurality of asset metadata objects. That is, the updated segmented allocation control structure can satisfy the first set of the plurality of parameters. For example, the update might involve recalibrating the asset token allocations to better align with current market conditions. Furthermore, the updated allocation token can be issued to reflect revised terms of investment. Additionally, a cascading process can be further performed where other segmented allocations could be updated based on shifts in the overarching investment strategy. For example, a broad market downturn might necessitate across-the-board adjustments to risk exposure.

In some implementations, the processors can provide, by the segmented allocation control structure to the client system, the updated allocation token. For example, the updated token can be transmitted via a secure electronic delivery system. In some implementations, the wallet system of the client system can automatically update to reflect the new token specifications. For example, the wallet might display updated token details and associated rights. Additionally, the processors can request and monitor, by the segmented allocation control structure, the outputs of the container control structure. Similar to above, a request can include information for enhanced data fidelity where the container control structure can refine data collection protocols. In some implementations, the outputs can include one or more performance metrics of the metadata of the subset of the plurality of asset metadata objects of the first segmented allocation. For example, the performance metrics could be yield rates, default rates, and recovery times. Furthermore, metadata of the subset of the plurality of asset metadata objects can include underlying physical asset information. For example, this could include property appraisals, equipment valuations, and inventory audits. In some implementations, the processors can determine an allocation distribution corresponding to the allocation token based on the one or more performance metrics of the first segmented allocation. For example, an allocation distribution can be calculated to proportionally distribute income where the underlying assets generate variable returns. In another example, an allocation distribution can be structured to provide lump-sum payouts where certain performance thresholds are met. In some implementations, the value or amount of the allocation distribution can be based on a formula that considers asset value appreciation and income generation. For example, the formula might adjust payouts based on seasonal fluctuations in revenue.

In some implementations, in response to determining the allocation distribution, the processors can automatically initiate an on-chain exchange of the allocation distribution from an instrument owner's wallet address to a mobile wallet address of the client system. The user can be the owner of the allocation token. That is, the allocation token can be used by the processors to authorize the transaction. In some implementations, an on-chain exchange includes accessing a blockchain and executing smart contract operations. Furthermore, the instrument owner's wallet address can correspond to an instrument owner with a security interest in one or more underlying physical assets of the first segmented allocation of the plurality of asset tokens. For example, the security interest could be registered as part of the blockchain transaction record. Additionally, the on-chain exchange can transfer ownership rights or revenue shares.

In some implementations, in response to determining the allocation distribution, the processors can automatically process an off-chain exchange from the instrument owner's wallet address to an account of a user operating the client system. The user can be the owner of the allocation token. That is, the allocation token can be used by the processors to facilitate the transfer. In some implementations, an off-chain exchange includes accessing a banking network and processing electronic funds transfers. Furthermore, the instrument owner's wallet address can correspond to an instrument owner with a security interest in one or more underlying physical assets of the first segmented allocation of the plurality of asset tokens. For example, the security interest could be a lien on real estate or a pledge of stock. Additionally, the off-chain exchange can transfer monetary payouts or dividends.

Additionally, the plurality of asset tokens can correspond to a controllable electronic record representing an ownership instrument of at least one security interest in at least one of the plurality of tokens. That is, the electronic record can be updated to reflect ownership changes or rights adjustments. For example, tokenized shares of a company could be updated to reflect a transfer of ownership. Furthermore, these updates can be made in real-time as transactions occur. Moreover, each update could be logged to ensure a traceable history of ownership changes. In some implementations, providing, by the segmented allocation control structure to the client system, the allocation token can be responsive to receiving a first allocation request including a first amount in exchange for a portion of an allocation distribution of the first segmented allocation. That is, the allocation request can be a purchase request of a particular allocation distribution. In some implementations, the segmented allocation control structure can validate the request and confirm the transaction terms. For example, the structure might verify the purchaser's credentials and ensure sufficient funds are available. In another example, terms might include specific conditions under which the distribution occurs. Thus, the allocation token can be provided upon completion of the transaction.

In some implementations, providing, by the segmented allocation control structure to the client system, the allocation token can be responsive to a re-allocation, after a threshold time period, of the first segmented allocation and receiving a second allocation exchange request including a second exchange amount for a re-allocated portion of a re-allocated allocation distribution of the re-allocated first segmented allocation. That is, the re-allocation can be based on updated investment strategies or market developments. Furthermore, the threshold period of time could be determined by market conditions or regulatory requirements. For example, re-allocation might occur quarterly or annually based on performance reviews. In some implementations, the segmented allocation control structure can review and approve the re-allocation request. For example, it can assess the impact of the re-allocation on overall portfolio balance. In another example, the approval process could involve stakeholder consultations. Thus, the allocation token can be provided following approval of the re-allocation plan.

In some implementations, artificial intelligence (AI) and/or generative AI (GAI) can be used by the processing circuits to perform method 500. Generally, one or more AI models, such as convolutional neural networks (CNNs), recurrent neural networks (RNNs), decision trees, support vector machines (SVM) for classification, gradient boosting machines (GBM) for predictive analytics, and decision trees for rule-based decision making can be used by the processing circuits to perform method 500. For example, at block 510 the processing circuits can employ an AI model (e.g., SVM) to classify asset tokens based on their attributes and historical data. In another example, at block 520 the processing circuits can use an AI model (e.g., GBM) to forecast the potential future values of assets based on trends derived from historical transaction data. In another example, at block 530 the processing circuits can utilize decision trees to determine the criteria for minting container tokens, incorporating logic that addresses various contingencies in token attributes. In yet another example, at block 540 the processing circuits can implement cryptographic secure hash algorithms like SHA-256 to encrypt token data. In yet another example, at block 550 the processing circuits can apply logistic regression models to determine the probability of asset performance meeting investor expectations. In yet another example, at block 560 the processing circuits can use rule-based AI systems to automatically check and enforce compliance with smart contract conditions when issuing allocation tokens. Additionally, one or more GAI models, such as deep reinforcement learning models for adaptive decision making and GANs for simulating and analyzing token interaction scenarios can be used by the processing circuits to perform method 500. For example, the processing circuits can leverage deep reinforcement learning to dynamically adjust smart contracts based on ongoing token performance and market changes. In another example, the processing circuits can utilize GANs to generate simulated data for stress testing token ecosystems under various economic conditions.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A system, comprising:
a data processing system comprising memory and one or more processing circuits configured to:
identify a plurality of asset tokens comprising links to a plurality of asset metadata objects;
generate a container metadata object comprising metadata of the plurality of asset tokens;
generate a container token comprising a link with the container metadata object;
encapsulate the container token and the plurality of asset tokens within a container comprising a container control structure restricting outputs of the container metadata object and the plurality of asset metadata objects;
generate an allocation token compatible with a segmented allocation control structure restricting outputs by the container of a first segmented allocation of the plurality of asset tokens based on metadata of a subset of the plurality of asset metadata objects;
provide, by the segmented allocation control structure to a client system, the allocation token;
request and monitor, by the segmented allocation control structure, the outputs of the container control structure, the outputs comprising one or more performance metrics of the metadata of the subset of the plurality of asset metadata objects of the first segmented allocation, wherein the metadata of the subset of the plurality of asset metadata objects comprises underlying physical asset information;
determine an allocation distribution corresponding to the allocation token based on the one or more performance metrics of the first segmented allocation; and
in response to determining the allocation distribution, either:
automatically initiate an on-chain exchange of the allocation distribution from an instrument owner's wallet address to a mobile wallet address of the client system, wherein the instrument owner's wallet address corresponds to an instrument owner with a security interest in one or more underlying physical assets of the first segmented allocation of the plurality of asset tokens; or
automatically process an off-chain exchange from the instrument owner's wallet address to an account of a user operating the client system.

2. The system of claim 1, wherein the one or more processing circuits are further configured to:
generate, by the segmented allocation control structure, a plurality of segmented allocations within the container based on an output of the container control structure corresponding to access to the plurality of asset metadata objects.

3. The system of claim 2, wherein generating the plurality of segmented allocations comprises applying a plurality of parameters to segment the plurality of asset tokens encapsulated within the container, and wherein the token is at least one of a fungible token or a non-fungible token (NFT).

4. The system of claim 3, wherein the one or more processing circuits are further configured to:
request and monitor, by the segmented allocation control structure, the outputs of the container control structure, the outputs comprising the metadata of the subset of the plurality of asset metadata objects of the first segmented allocation;
determine at least one of the plurality of asset tokens of the first segmented allocation conflicts with a first set of the plurality of parameters;
generate an updated allocation token compatible with the segmented allocation control structure restricting the output by the container of an updated segmented allocation of the plurality of asset tokens based on metadata of an updated subset of the plurality of asset metadata objects, the updated allocation token satisfying the first set of the plurality of parameters; and
provide, by the segmented allocation control structure to the client system, the updated allocation token.

5. The system of claim 3, wherein the first segmented allocation comprises a first plurality of the plurality of asset tokens satisfying a first set of the plurality of parameters, and a second segmented allocation comprising a second plurality of the plurality of asset tokens satisfying a second set of the plurality of parameters.

6. The system of claim 1, wherein each of the plurality of asset tokens correspond to a controllable electronic record representing an ownership instrument of at least one security interest in at least one of the plurality of tokens.

7. The system of claim 1, wherein providing, by the segmented allocation control structure to the client system, the allocation token is responsive to (1) receiving a first allocation request comprising a first amount in exchange for a portion of an allocation distribution of the first segmented allocation or (2) a re-allocation, after a threshold time period, of the first segmented allocation and receiving a second allocation exchange request comprising a second exchange amount for a re-allocated portion of a re-allocated allocation distribution of the re-allocated first segmented allocation.

8. A method, comprising:
identifying, by one or more processing circuits, a plurality of asset tokens comprising links to a plurality of asset metadata objects;
generating, by the one or more processing circuits, a container metadata object comprising metadata of the plurality of asset tokens;
generating, by the one or more processing circuits, a container token comprising a link with the container metadata object;
encapsulating, by the one or more processing circuits, the container token and the plurality of asset tokens within a container comprising a container control structure restricting outputs of the container metadata object and the plurality of asset metadata objects;
generating, by the one or more processing circuits, an allocation token compatible with a segmented allocation control structure restricting outputs by the container of a first segmented allocation of the plurality of asset tokens based on metadata of a subset of the plurality of asset metadata objects;
providing, by the one or more processing circuits using the segmented allocation control structure to a client system, the allocation token;
requesting and monitoring, by the one or more processing circuits by the segmented allocation control structure, the outputs of the container control structure, the outputs comprising one or more performance metrics of the metadata of the subset of the plurality of asset metadata objects of the first segmented allocation, wherein the metadata of the subset of the plurality of asset metadata objects comprises underlying physical asset information;
determining, by the one or more processing circuits, an allocation distribution corresponding to the allocation token based on the one or more performance metrics of the first segmented allocation; and
in response to determining the allocation distribution, either:
automatically initiating, by the one or more processing circuits, an on-chain exchange of the allocation distribution from an instrument owner's wallet address to a mobile wallet address of the client system, wherein the instrument owner's wallet address corresponds to an instrument owner with a security interest in one or more underlying physical assets of the first segmented allocation of the plurality of asset tokens; or
automatically processing, by the one or more processing circuits, an off-chain exchange from the instrument owner's wallet address to an account of a user operating the client system.

9. The method of claim 8, further comprising:
generating, by the one or more processing circuits using the segmented allocation control structure, a plurality of segmented allocations within the container based on an output of the container control structure corresponding to access to the plurality of asset metadata objects.

10. The method of claim 9, wherein generating the plurality of segmented allocations comprises applying a plurality of parameters to segment the plurality of asset tokens encapsulated within the container, and wherein the token is at least one of a fungible token or a non-fungible token (NFT).

11. The method of claim 10, further comprising:
requesting and monitoring, by the one or more processing circuits using the segmented allocation control structure, the outputs of the container control structure, the outputs comprising the metadata of the subset of the plurality of asset metadata objects of the first segmented allocation;
determining, by the one or more processing circuits, at least one of the plurality of asset tokens of the first segmented allocation conflicts with a first set of the plurality of parameters;
generating, by the one or more processing circuits, an updated allocation token compatible with the segmented allocation control structure restricting the output by the container of an updated segmented allocation of the plurality of asset tokens based on metadata of an updated subset of the plurality of asset metadata objects, the updated allocation token satisfying the first set of the plurality of parameters; and
providing, by the one or more processing circuits using the segmented allocation control structure to the client system, the updated allocation token.

12. The method of claim 10, wherein the first segmented allocation comprises a first plurality of the plurality of asset tokens satisfying a first set of the plurality of parameters, and a second segmented allocation comprising a second plurality of the plurality of asset tokens satisfying a second set of the plurality of parameters.

13. The method of claim 8, wherein each of the plurality of asset tokens correspond to a controllable electronic record representing an ownership instrument of at least one security interest in at least one of the plurality of tokens.

14. The method of claim 8, wherein providing, by the segmented allocation control structure to the client system, the allocation token is responsive to (1) receiving a first allocation request comprising a first amount in exchange for a portion of an allocation distribution of the first segmented allocation or (2) a re-allocation, after a threshold time period, of the first segmented allocation and receiving a second allocation exchange request comprising a second exchange amount for a re-allocated portion of a re-allocated allocation distribution of the re-allocated first segmented allocation.

15. A non-transitory computer readable medium (CRM) comprising one or more instructions stored thereon that, when executed by one or more processing circuits, cause the one or more processing circuits to perform operations comprising:
identifying a plurality of asset tokens comprising links to a plurality of asset metadata objects;
generating a container metadata object comprising metadata of the plurality of asset tokens;
generating a container token comprising a link with the container metadata object;
encapsulating the container token and the plurality of asset tokens within a container comprising a container control structure restricting outputs of the container metadata object and the plurality of asset metadata objects;
generating an allocation token compatible with a segmented allocation control structure restricting outputs by the container of a first segmented allocation of the plurality of asset tokens based on metadata of a subset of the plurality of asset metadata objects; and
providing, by the segmented allocation control structure to a client system, the allocation token.

16. The non-transitory CRM of claim 15, wherein the one or more instructions, when executed by the one or more processing circuits, further cause the one or more processing circuits to perform operations comprising:
generating, by the segmented allocation control structure, a plurality of segmented allocations within the container based on an output of the container control structure corresponding to access to the plurality of asset metadata objects.

17. The non-transitory CRM of claim 16, wherein generating the plurality of segmented allocations comprises applying a plurality of parameters to segment the plurality of asset tokens encapsulated within the container, and wherein the token is at least one of a fungible token or a non-fungible token (NFT).

18. The non-transitory CRM of claim 17, wherein the one or more instructions, when executed by the one or more processing circuits, further cause the one or more processing circuits to perform operations comprising:
requesting and monitoring, by the segmented allocation control structure, the outputs of the container control structure, the outputs comprising the metadata of the subset of the plurality of asset metadata objects of the first segmented allocation;
determining at least one of the plurality of asset tokens of the first segmented allocation conflicts with a first set of the plurality of parameters;
generating an updated allocation token compatible with the segmented allocation control structure restricting the output by the container of an updated segmented allocation of the plurality of asset tokens based on metadata of an updated subset of the plurality of asset metadata objects, the updated allocation token satisfying the first set of the plurality of parameters; and
providing, by the segmented allocation control structure to the client system, the updated allocation token.

19. The non-transitory CRM of claim 17, wherein the first segmented allocation comprises a first plurality of the plurality of asset tokens satisfying a first set of the plurality of parameters, and a second segmented allocation comprising a second plurality of the plurality of asset tokens satisfying a second set of the plurality of parameters.

20. The non-transitory CRM of claim 15, wherein the one or more instructions, when executed by the one or more processing circuits, further cause the one or more processing circuits to perform operations comprising:
requesting and monitoring, by the segmented allocation control structure, the outputs of the container control structure, the outputs comprising one or more performance metrics of the metadata of the subset of the plurality of asset metadata objects of the first segmented allocation, wherein the metadata of the subset of the plurality of asset metadata objects comprises underlying physical asset information;
determining an allocation distribution corresponding to the allocation token based on the one or more performance metrics of the first segmented allocation; and
in response to determining the allocation distribution, either:
automatically initiating an on-chain exchange of the allocation distribution from an instrument owner's wallet address to a mobile wallet address of the client system, wherein the instrument owner's wallet address corresponds to an instrument owner with a security interest in one or more underlying physical assets of the first segmented allocation of the plurality of asset tokens; or
automatically processing an off-chain exchange from the instrument owner's wallet address to an account of a user operating the client system;
wherein each of the plurality of asset tokens correspond to a controllable electronic record representing an ownership instrument of at least one security interest in at least one of the plurality of tokens.
